(19) United States
(12) Patent Application Publication
(10) Pub. No.: US 2011/0001891 A1
(43) Pub. Date: Jan. 6, 2011

(54) ILLUMINATING DEVICE, DISPLAY DEVICE, AND TELEVISION RECEIVER

(75) Inventor: Takahiro Yoshikawa, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/865,874

(22) PCT Filed: Feb. 2, 2009
(86) PCT No.: PCT/JP2009/051724

§ 371 Date: Aug. 3, 2010

(30) Foreign Application Priority Data
Feb. 27, 2008 (JP) 2008-046780

(51) Int. Cl. H04N 5/14; F21V 7/00; G02F 1/13357; G02F 1/1335

(52) U.S. Cl. 348/790; 362/310; 362/97.1; 349/62; 348/E05.062

(57) ABSTRACT

A backlight device 12 includes a chassis 14, a cold-cathode tube 17 that is disposed in the chassis 14, a main body 27 that is mounted on the chassis 14, a lamp clip 18 that is provided in the main body 27 so as to grip the cold-cathode tube 17, and a reflecting sheet 23 that is disposed in the chassis 14. The reflecting sheet has an opening 41 through which the lamp gripping portion 28 is passed, and an inner edge portion of the opening 41 covers an outer edge portion of the main body 27.

### TECHNICAL FIELD

The present invention relates to an illuminating device, a display device, and a television receiver.

### BACKGROUND ART

For example, a liquid crystal panel that is used in liquid crystal display devices such as a liquid crystal television does not emit light by itself, and it is therefore necessary to separately provide a backlight device as an illuminating device. The backlight device is configured to be placed on the backside (side opposite to s display surface) of the liquid crystal panel. The backlight device includes a metal or resin chassis in which a surface on the liquid crystal panel side is opened, a reflecting sheet laid on a chassis, a plurality of fluorescent tubes (such as cold-cathode tubes) that are accommodated as the lamp in the chassis, a plurality of optical members (such as diffuser sheets) that are disposed in the opening portion of the chassis to efficiently send the light emitted from the cold-cathode tube onto the liquid crystal panel side, and a lamp clip that supports a middle portion of the elongated cold-cathode tube. The lamp clip has a configuration in which a lamp gripping portion that grips the cold-cathode tube is provided in a plate-like main body mounted on a bottom plate of the chassis.

When the cold-cathode tube is lit, a slight decrease in light quantity of the cold-cathode tube is inevitable in the lamp gripping portion. As a result, there is a risk of observing part of the main body as a faint shadow on the liquid crystal panel.

For example, Patent Document 1 proposes a technology of preventing the generation of the shadow in the main body. In the technology proposed in Patent Document 1, the main body is formed into a triangular shape in section, and an inclined surface is formed in a surface of the main body, and the light with which the main body is illuminated from both sides of the portion of the cold-cathode tube griped by the lamp gripping portion can be reflected toward the liquid crystal panel by the inclined surface. Therefore, the generation of the shadow is prevented in the main body.

Patent Document 1: Japanese Patent Publication Laid-Open No. 2005-17691

### PROBLEM TO BE SOLVED BY THE INVENTION

In the technology described in Patent Document 1, the generation of the shadow is prevented in the main body by devising the shape of the lamp clip. However, it is necessary to newly produce a lamp clip having a particular structure, and it is necessary to replace a general-purpose product conventionally used with the new lamp clip. This results in a problem of cost increase. Therefore, there is a demand for proposing another solving means as the solving means for suppressing the shadow of the main body, that is, luminance unevenness.

On the other hand, since the luminance unevenness is possibly generated by a difference in reflection efficiency between the lamp clip and the reflecting sheet, the problem of the generation of the luminance unevenness is hardly solved by the technology described in Patent Document 1. That is, there is a risk that the technology described in Patent Document 1 might be insufficient as the countermeasure for the luminance unevenness.

Specifically, in recent years, the demand for the thinner liquid crystal display device arises. When the backlight device is thinned in response to the demand, the luminance unevenness is easily generated by the reason such as a distance between the optical member and the cold-cathode tube is shortened. Therefore, the advanced countermeasure for the luminance unevenness tends to be required.

The above-described problem similarly occurs in the backlight device that includes an optical member support having a configuration in which a support pin is provided in the main body in order to support the optical member.

### DISCLOSURE OF THE INVENTION

The present invention has been accomplished in view of the foregoing, and an object of the invention is to preferably reduce the luminance unevenness.

### MEANS FOR SOLVING THE PROBLEM

An illuminating device according to the present invention includes a chassis, a lamp disposed in the chassis, a lamp holder mounted to the chassis and a reflecting member disposed in the chassis. The lamp holder includes a main body and a lamp gripping portion. The lamp gripping portion is provided on the main body so as to grip the lamp. The reflecting member has an opening through which the lamp gripping portion is passed and an inner edge portion thereof covers an outer edge portion of the main body.

The lamp gripping portion that grips the lamp, the lamp gripping portion being included in the lamp holder, is passed through the opening of the reflecting member, and the outer edge portion of the main body is covered with the inner edge portion of the opening, which hardly visually recognizes as the shadow the outer edge portion of the main body that forms the step between the outer edge portion and the chassis. In the present invention, the reflecting member reduces the generation of the shadow in the outer edge portion of the main body, thereby enabling the use of the general-purpose product as the lamp holder to achieve the cost reduction. Additionally, because the lamp holder is covered with the reflecting member, the ratio of the surface area of the lamp holder to the surface area of the reflecting member is decreased. As a consequence, the luminance unevenness is hardly generated even if the lamp holder differs from the reflecting member in the reflection efficiency. Therefore, this configuration is suitable to the thinner liquid crystal display panel. As used herein, the “surface area” means an area of a portion in which the reflecting member or the lamp holder is exposed to the lamp.

### BRIEF DESCRIPTION OF DRAWINGS

FIG. 1 is an exploded perspective view illustrating a schematic configuration of a television receiver according to a first embodiment of the invention.

FIG. 2 is an exploded perspective view illustrating a schematic configuration of a liquid crystal display device.

FIG. 3 is a sectional view illustrating a state in which the liquid crystal display device is cut along a short-side direction.

FIG. 4 is a sectional view illustrating a state in which the liquid crystal display device is cut along a long-side direction.

FIG. 5 is a side view of the lamp clip.

FIG. 6 is a plan view illustrating a state in which lamp clips are mounted on a chassis.

FIG. 7 is a plan view of a reflecting sheet.

FIG. 8 is a plan view of an opening.

FIG. 9 is a sectional view illustrating mounted states of the lamp clip and the reflecting sheet in a liquid crystal display device.

FIG. 10 is a plan view illustrating a state in which the lamp clip and the reflecting sheet are mounted on the chassis.

FIG. 11 is a sectional view illustrating a state in which the reflecting sheet is attached to the chassis, on which the lamp clip is mounted.

FIG. 12 is a plan view illustrating a relationship between a lamp clip and an opening according to a second embodiment of the invention.

FIG. 13 is a plan view illustrating an opening of a reflecting sheet according to a third embodiment of the invention.

FIG. 14 is a sectional view illustrating a state before the reflecting sheet is attached to a chassis, on which a lamp clip is mounted.

FIG. 15 is a sectional view illustrating mounted states of the lamp clip and the reflecting sheet.

FIG. 16 is a plan view illustrating a relationship between the lamp clip and the opening.

FIG. 17 is a plan view illustrating a relationship between a lamp clip and an opening according to a fourth embodiment of the invention.

FIG. 18 is a sectional view illustrating mounted states of a lamp clip and a reflecting sheet according to a fifth embodiment of the invention.

FIG. 19 is a sectional view illustrating a state before the reflecting sheet is attached to a chassis, on which the lamp clip is mounted.

FIG. 20 is a sectional view illustrating mounted states of a lamp clip and a reflecting sheet according to a sixth embodiment of the invention.

FIG. 21 is a plan view illustrating a relationship between the lamp clip and an opening.

FIG. 22 is a sectional view illustrating mounted states of a lamp clip and a reflecting sheet according to a seventh embodiment of the invention.

FIG. 23 is a sectional view illustrating mounted states of an optical member support and a reflecting sheet according to an eighth embodiment of the invention.

FIG. 24 is a plan view illustrating a relationship between a lamp clip and an opening according to another embodiment (2) of the invention.

### BEST MODES FOR CARRYING OUT THE INVENTION

### First Embodiment

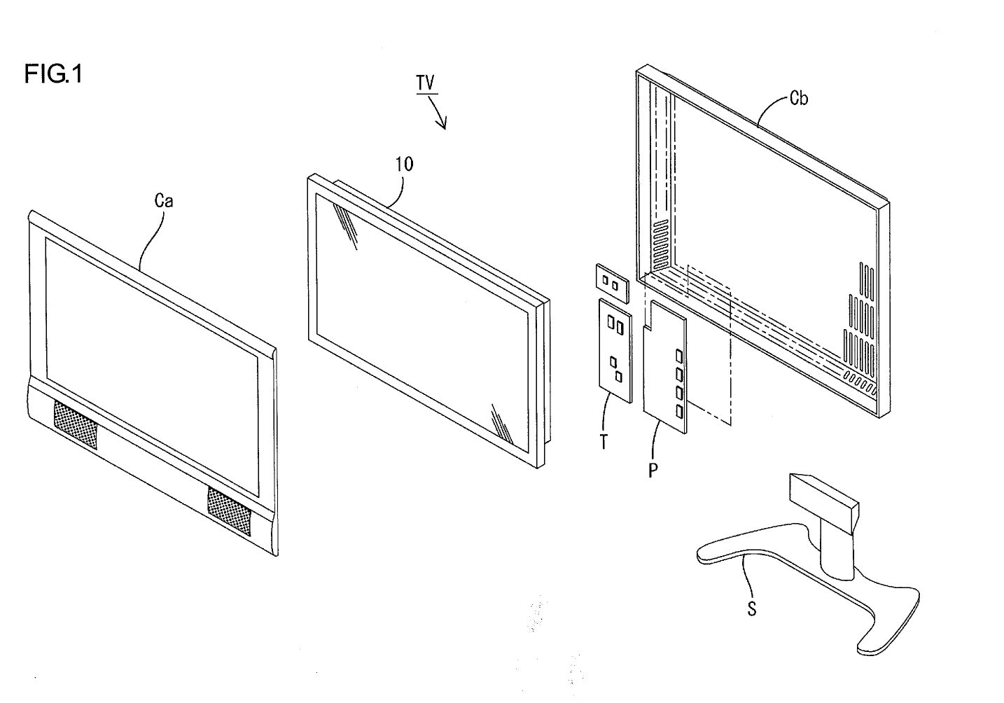

A first embodiment of the invention will be described with reference to FIGS. 1 to 11.

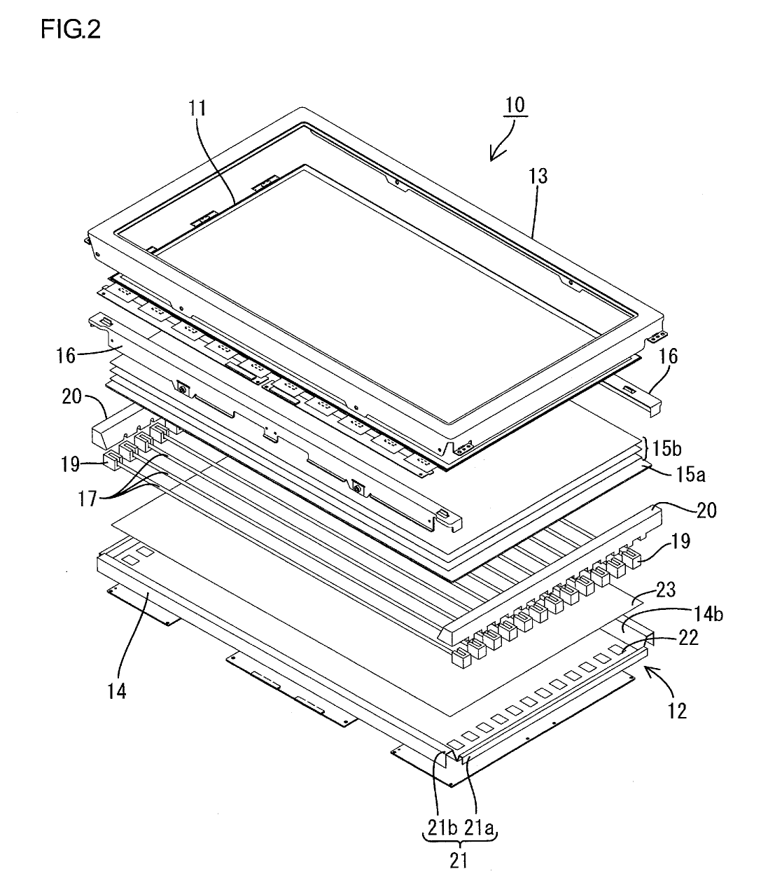

As illustrated in FIG. 1, a television receiver TV of the first embodiment is configured to include a liquid crystal display device 10, front and back cabinets Ca and Cb that accommodate the liquid crystal display device 10 so as to sandwich therebetween, a power supply P, a tuner T, and a stand S. The liquid crystal display device (display device) 10 is formed into a horizontally-long rectangular shape as a whole and accommodated in a vertically standing state. As illustrated in FIG. 2, the liquid crystal display device 10 includes a liquid crystal panel 11 that is of a display panel and a backlight device (illuminating device) 12 that is of an external light source, and the liquid crystal panel 11 and the backlight device 12 are configured to be integrally retained by a frame-like bezel 13. An X-axis, a Y-axis, and a Z-axis are illustrated in some drawings, and the drawings are made such that each axis direction becomes a direction illustrated in each drawing.

The liquid crystal panel 11 and the backlight device 12, which constitute the liquid crystal display device 10, will be described below (see FIGS. 2 to 4).

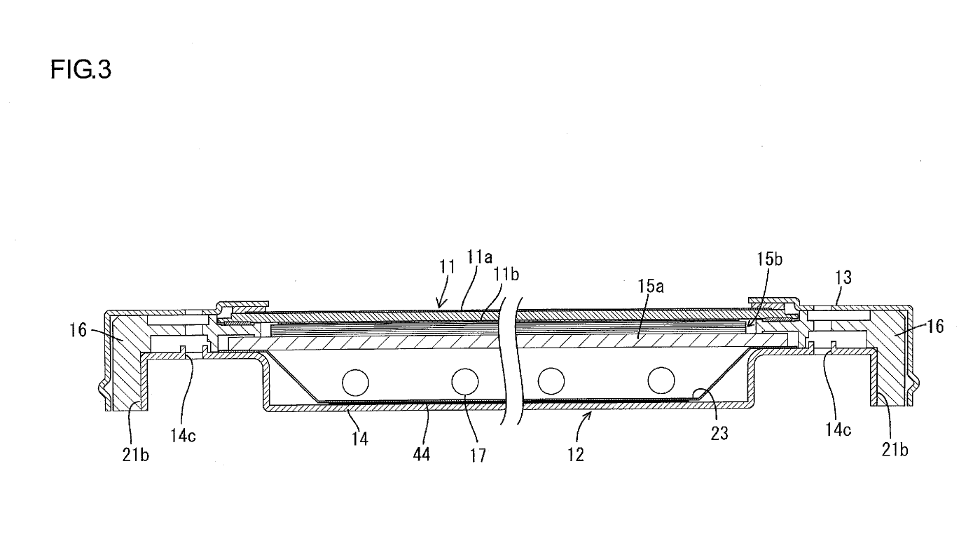

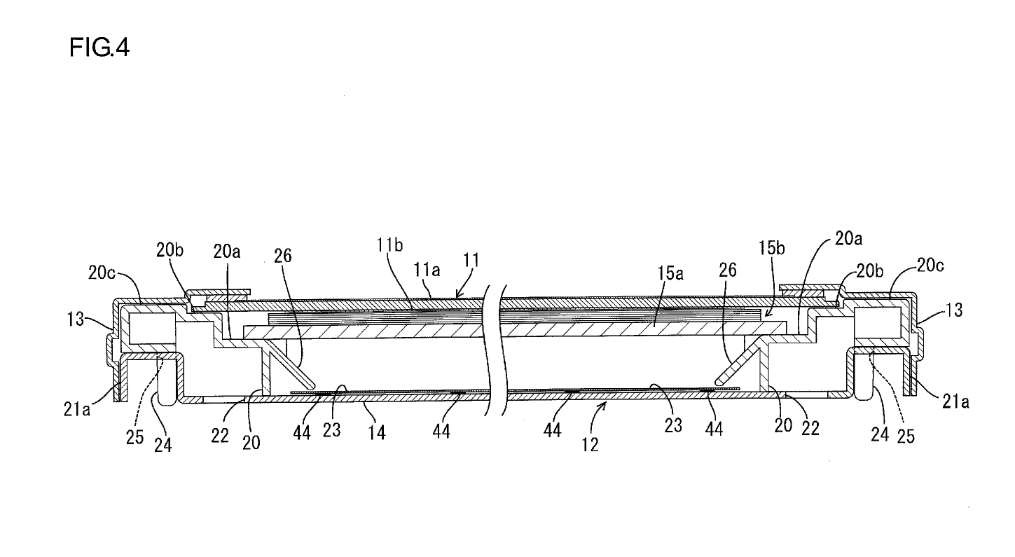

In a configuration of the liquid crystal panel (display panel) 11, a pair of glass substrates is bonded with a given gap, and liquid crystal is sealed between the glass substrates. One of the glass substrates is provided with switching elements (for example, TFT) connected to source interconnections and gate interconnections, which are orthogonal to each other, pixel electrodes connected to the switching elements, an oriented film, and the like. The other glass substrate is provided with a color filter in which colored portions such as R (red), G (green), and B (blue) are arrayed into a given matrix shape, a counter electrode, an oriented film, and the like. Polarizing plates 11a and 11b are disposed outside the substrates (see FIGS. 3 and 4).

As illustrated in FIG. 2, the backlight device 12 includes a substantially box-shaped chassis 14 that is opened onto a light outgoing surface side (side of the liquid crystal panel 11), a diffuser plate 15a that is disposed so as to cover an opening 14b of the chassis 14, the plurality of optical sheets 15b disposed between the diffuser plate 15a and the liquid crystal panel 11, and frames 16 that are disposed along long sides of the chassis 14 and retain long-side edge portions of the diffuser plate 15a while the long-side edge portions are sandwiched between the frames 16 and the chassis 14. The chassis 14 further includes cold-cathode tubes (light sources) 17, lamp clips 18 that are used to mount the cold-cathode tube 17 on the chassis 14, relay connectors 19 that relay electric connection in each end portion of the cold-cathode tube 17, and holders 20 that collectively covers end portions of a group of the cold-cathode tubes 17 and a group of the relay connectors 19. In the backlight device 12, the diffuser plate 15a is located closer to the light outgoing side than the cold-cathode tube 17. In FIGS. 2 to 4, the lamp clips 18 are not illustrated.

The chassis 14 is made of metal and formed into a shallow substantially box shape through sheet-metal processing. The chassis 14 includes a rectangular bottom plate and a folded outer edge portion (a folded outer edge portion 21a in a short-side direction and a folded outer edge portion 21b in a long-side direction) that is vertically folded into a substantially U-shape from each side. A plurality of mounting holes 22 are made in both end portions in a long-side direction of a bottom plate of the chassis 14 to mount the relay connectors 19. As illustrated in FIG. 3, a fixing hole 14c is made in an upper surface of the folded outer edge portion 21b of the chassis 14, and the bezel 13, the frame 16, the chassis 14 and the like can be integrated by, for example, a screw.

A reflecting sheet 23 is provided on an inner surface side (the side of the surface opposite to the cold-cathode tube 17 or the diffuser plate 15a, surface side) of the bottom plate of the chassis 14. The reflecting sheet 23 is made of a synthetic resin, the surface of the reflecting sheet 23 is colored in white that is excellent in reflectivity, and the reflecting sheet 23 has a rectangular shape as the chassis 14 and is spread along the inside of the bottom plate surface of the chassis 14 so as to cover the substantially whole area of the bottom plate surface. The reflecting sheet 23 constitutes a reflecting plane that reflects the light emitted from the cold-cathode tube 17 in the chassis 14 toward the side of the diffuser plate 15a. As illustrated in FIG. 3, the long-side edge portion of the reflecting sheet 23 rises so as to cover the folded outer edge portion 21b of the chassis 14, and is sandwiched between the chassis 14 and the diffuser plate 15a. The reflecting sheet 23 allows light emitted from the cold-cathode tube 17 to be reflected toward the side of the diffuser plate 15a.

The cold-cathode tube 17 is formed into an elongated tubular shape. A plurality of the cold-cathode tubes 17 are in parallel with one another to be accommodated in the chassis 14 while length directions (axial direction) of the cold-cathode tubes 17 are aligned with the long-side direction of the chassis 14 (see FIG. 2). The arrangement direction of the cold-cathode tube 17 coincides with the Y-axis direction, that is, the short-side direction of the chassis 14. The cold-cathode tube 17 floats slightly from the bottom plate of the chassis 14, and the end portions of the cold-cathode tube 17 are fitted in the relay connector 19. The holder 20 is mounted so as to cover the relay connector 19.

The holder 20 is made of a white synthetic resin. The holder 20 covers the end portion of the cold-cathode tube 17 and has an elongated substantially box shape extending along the short-side direction of the chassis 14. As illustrated in FIG. 4, the holder 20 has a stepwise surface of which the diffuser plate 15a and the liquid crystal panel 11 can be placed unevenly on the surface side, and the holder 20 is provided while partially overlapping the folded outer edge portion 21a in the short-side direction of the chassis 14. The holder 20 and the folded outer edge portion 21a constitute a sidewall of the backlight device 12. An insertion pin 24 is projected from a surface of the holder 20 opposite to the folded outer edge portion 21a of the chassis 14. The insertion pin 24 is inserted in an inserting hole 25 made in an upper surface of the folded outer edge portion 21a of the chassis 14, thereby mounting the holder 20 on the chassis 14.

The stepwise surface of the holder 20 includes three surfaces that are parallel to the bottom plate surface of the chassis 14, and the short-side edge portion of the diffuser plate 15a is placed on a first surface 20a that is located at the lowest position. An inclined cover 26 that is inclined toward the bottom plate surface of the chassis 14 extends from the first surface 20a. The short-side edge portion of the liquid crystal panel 11 is placed on a second surface 20b in the stepwise surface of the holder 20. A third surface 20c that is located at the highest position in the stepwise surface of the holder 20 is provided at a position at which the third surface 20c overlaps the folded outer edge portion 21a of the chassis 14, and the third surface 20c is in contact with the bezel 13.

The diffuser plate 15a is formed by a synthetic-resin plate-like member in which light scattering particles are blended in a dispersed manner. The diffuser plate 15a has a function of diffusing linear light emitted from the cold-cathode tube 17 that is of the tubular light source. As described above, the short-side edge portion of the diffuser plate 15a is placed on the first surface 20a of the holder 20, is not subjected to a constraint force in a vertical direction. On the other hand, as illustrated in FIG. 3, the long-side edge portion of the diffuser plate 15a is fixed while sandwiched between the chassis 14 (reflecting sheet 23) and the frame 16.

In the optical sheet 15b disposed on the diffuser plate 15a is constituted such that a diffuser sheet, a lens sheet, and a reflection type polarizing plate are sequentially stacked from the side of the diffuser plate 15a. The optical sheet 15b has a function of shaping the light, which is emitted from the cold-cathode tube 17 to pass through the diffuser plate 15a, into planar light. The liquid crystal panel 11 is placed on the upper surface side of the optical sheet 15b, and the optical sheet 15b is retained while sandwiched between the diffuser plate 15a and the liquid crystal panel 11.

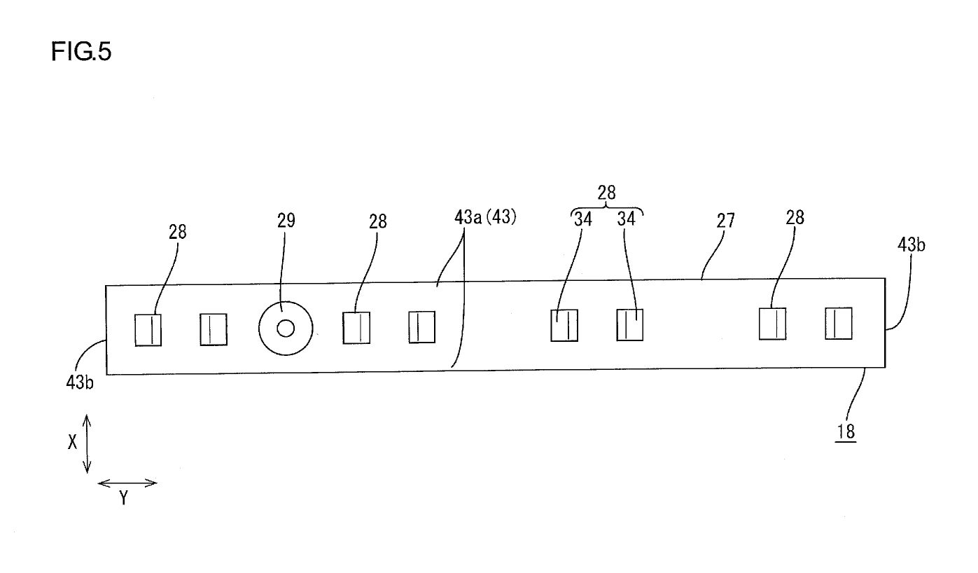

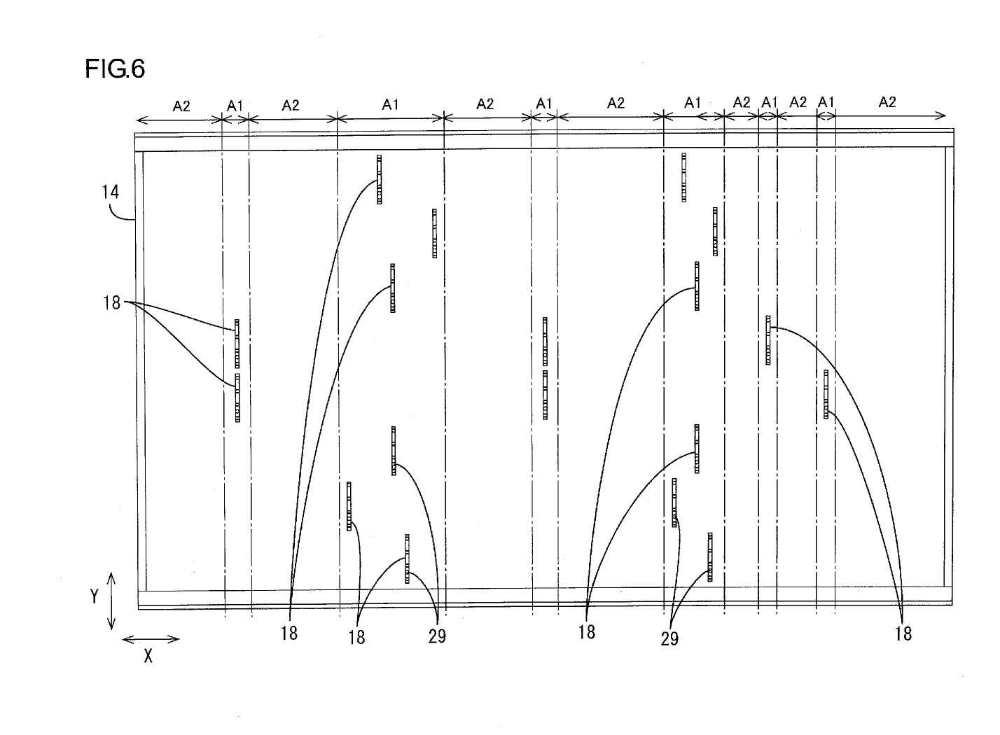

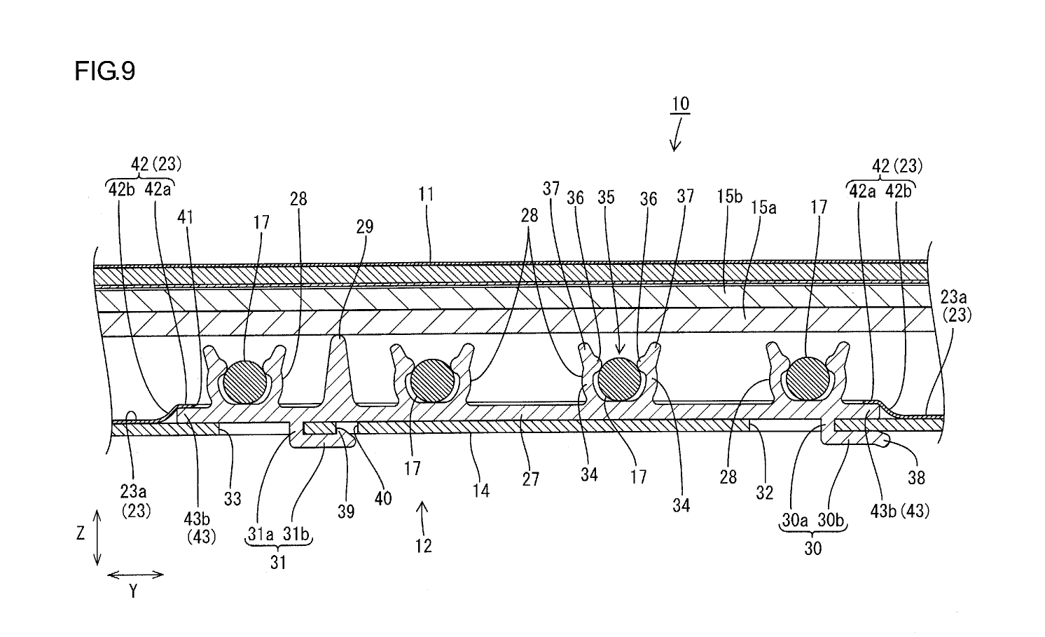

The lamp clip 18 will be described in detail. The lamp clip 18 is made of a synthetic resin (for example, polycarbonate), and the surface of the lamp clip 18 is colored in white that is excellent in reflectivity. As illustrated in FIGS. 5 and 9, the lamp clip 18 includes a main body 27 (mounting plate, base portion) that is formed into a substantially plate-like shape along the bottom plates of the chassis 14. The main body 27 has a substantially rectangular shape when viewed from above. The lamp clip 18 is, as shown in FIG. 6, mounted on the chassis 14 while the length direction (long-side direction) of the main body 27 is provided (oriented) along the Y-axis direction and in substantially parallel with the short-side direction of the chassis 14. In other words, the lamp clip 18 is mounted on the chassis 14 while the length direction of the main body 27 is provided in substantially parallel with the direction orthogonal to the axial direction (length direction, X-axis direction) of the cold-cathode tube 17. In the following description, for the Z-axis direction, the upper side illustrated in FIG. 9 is set to a front side and the lower side is set to the backside.

A lamp gripping portion 28 that holds the cold-cathode tube 17 at a predetermined height and a support pin 29 that supports the diffuser plate 15a at a position higher than that of the cold-cathode tube 17 are provided on a front surface (surface opposite to the diffuser plate 15a and cold-cathode tube 17, the surface on the side opposite from the chassis 14 side) of the main body 27 as shown in FIGS. 5 and 9. Plural (in the first embodiment, four) lamp gripping portions 28 is provided in parallel in the length direction of the main body 27 while separated from one another, to grip the different cold-cathode tubes 17. Pitches between the lamp gripping portions 28 are substantially equal to one another, and the pitch between the lamp gripping portions 28 is substantially matched with a pitch between the cold-cathode tubes 17 arrayed in the chassis 14. The lamp gripping portions 28 are point-symmetrically provided with respect to the center of the main body 27, more specifically, a central position in the long-side direction (length direction, Y-axis direction) of the main body 27 and a central position in the short-side direction (width direction, X-axis direction). Each lamp gripping portion 28 is provided while deviating from the center of the main body 27 by a predetermined distance. The support pin 29 is disposed at a position that slants (deviates) from the above-described center of the main body 27, that is, an eccentric position. The support pin 29 is disposed in a substantially middle position between a lamp gripping portion 28 that is located closest to the end of the main body 27 and a lamp gripping portion 28 that is adjacent to the lamp gripping portion 28 located closest to the end of the main body 27. On the other hand, mounting portions 30 and 31 are provided in the surface (surface opposite to the chassis 14, the surface on the side opposite to the sides of the diffuser plate 15a and cold-cathode tube 17) on the backside of the main body 27. The mounting portions 30 and 31 maintain the lamp clip 18 in the state of being mounted on the chassis 14. The mounting portions 30 and 31 are disposed while separated from each other in the long-side direction of the main body 27. In order to distinguish the mounting portions 30 and 31 from each other, the mounting portions 30 and 31 are sequentially referred to as a first mounting portion 30 and a second mounting portion 31 from the left of FIG. 9.

As illustrated in FIG. 6, the plurality of lamp clips 18 are placed at dispersed positions in the inner surface of the bottom plates of the chassis 14. The arrangement of the lamp clips 18 will be described below. The lamp clips 18 are placed in parallel at the plural positions that are separated from one another in the long-side directions (X-axis directions) of the chassis 14 and reflecting sheet 23. Therefore, the cold-cathode tube 17 can be gripped at plural positions that are separated from one another in the axial direction. The lamp clips 18 are disposed all over the chassis 14 in the short-side direction, that is, the direction in which the cold-cathode tubes 17 are arrayed, and all the cold-cathode tubes 17 arrayed in the chassis 14 can be retained by the lamp clips 18. In the bottom plates of the chassis 14, the number of lamp clips 18 placed on the central side in the short-side direction (Y-axis direction) is larger than the number of lamp clips 18 placed on the end side. Specifically, each three lamp clips 18 are placed on the central side in the short-side directions of the chassis 14 and reflecting sheet 23 while separated from one another in the long-side direction, and the each two lamp clips 18 are placed close to both ends in the short-side direction from the six central-side lamp clips 18 while separated from one another in the long-side direction. Therefore, the number of lamp gripping portions 28 on the central side in the short-side directions of the chassis 14 is larger than the number of lamp gripping portions 28 on the end side, that is, the number of points that support the cold-cathode tube 17 on the central side is larger than the number of points that support the cold-cathode tube 17 on end side. In addition, the number of support pins 29 on the central side is larger than the number of support pins 29 on end side, that is, the number of points that support the diffuser plate 15a on the central side is larger than the number of points that support the diffuser plate 15a on end side.

Each two lamp clips 18 (lamp clips 18 disposed on both the end sides in the short-side direction with respect to the central side) arrayed in the long-side directions of the chassis 14 are disposed at positions that deviate in the long-side direction with respect to the lamp clips 18 adjacent to each other in the short-side direction. Accordingly, compared with the case in which the lamp clips 18 are arrayed in line along the short-side direction, a shadow of the lamp clip 18 is hardly visible from a human eye characteristic because the lamp clips 18 are disposed in the dispersed manner in the bottom plate surface of the reflecting sheet 23. Assuming that the number of lamp clips 18 are equal, it is easily visible from the human eye characteristic when the lamp clips 18 is disposed linearly or collectively, while the luminance unevenness is hardly generated in the backlight device 12 by disposing the lamp clips 18 in the dispersed manner like the present embodiment even if the reflecting sheet 23 differs from the lamp clip 18 in reflectance.

As described above, although the lamp clips 18 are disposed in the dispersed manner to some extent in the chassis 14, the existing range of the lamp clips 18 is limited to the specific range in the long-side direction of the chassis 14. In other words, mounting regions Al where the lamp clips 18 are mounted in the long-side direction of the chassis 14 and non-mounting regions A2 where the lamp clips 18 are not mounted are alternately arrayed in the chassis 14. Each of the mounting region Al and the non-mounting region A2 has a predetermined width in the long-side direction of the chassis 14 and is formed into a strip shape extended along the short-side direction of the chassis 14.

Two mounting holes 32 and 33 are formed in the inner surfaces of the bottom plates of the chassis 14 for inserting the mounting portions 30 and 31 to positions at which each of the lamp clips 18 should be mounted while piercing in a thickness direction. In order to distinguish the mounting holes 32 and 23 from each other, the mounting holes 32 and 33 are sequentially referred to as a first mounting hole 32 and a second mounting hole 33 from the left illustrated in FIG. 9. The mounting portions 30 and 31, the mounting holes 32 and 33, and the insertion holes 34 and 35 are described in detail later.

The lamp gripping portion 28 constituting a support structure for the cold-cathode tube 17 will be described in detail. As illustrated in FIG. 5, the lamp gripping portion 28 is disposed in the substantially center in the short-side direction of the main body 27, and a dimension in the X-axis direction of the lamp gripping portion 28 is set smaller than a short-side dimension of the main body 27. As illustrated in FIG. 9, the lamp gripping portion 28 can support an portion between both end portions of the cold-cathode tube 17 in which the electrodes are placed, that is, a light emitting portion from the backside at a predetermined height position. The lamp gripping portion 28 has an annular shape with end, which is opened to the front side, as a whole. The lamp gripping portion 28 includes a pair of arm portions 34 that is opposite to each other. An opening 35 is secured between leading end portions of arm portions 34 to permit the cold-cathode tube 17 to pass therethrough. The cold-cathode tube 17 is mounted/removed along the Z-axis direction (thickness directions of the bottom plates of the chassis 14). The arm portions 34 are formed into cantilever shapes that rise up from the position separated from each other in the length direction (Y-axis direction) in the surface on the front side of the main body 27, and the arm portion 34 is curved into a substantially arc shape. The inner circumference surfaces of the arm portions 34 are formed into arc shapes along the outer circumference surface of the cold-cathode tube 17 to be mounted. The arm portions 34 are symmetrically formed in relation to a symmetrical axis along the Z-axis direction, and the symmetrical axis passes through the central position in the Y-axis direction of the lamp gripping portion 28. The arm portions 34 can elastically be deformed along a width direction while a rising base end portion from the main body 27 is used as a fulcrum point.

A retaining projection 36 is provided in the inner surface (inner circumferential surface opposite to the cold-cathode tube 17) in a leading end portion of the arm portion 34 in order to retain the cold-cathode tube 17, and the opening 35 described above is secured between the retaining projections 36. The width of the opening 35 is set slightly narrower than an outside diameter dimension of the cold-cathode tube 17. Accordingly, in mounting or removing the cold-cathode tube 17 through the opening 35, the cold-cathode tube 17 presses the arm portions 34, whereby the arm portions 34 are elastically deformed and expanded. The retaining projection 36 hangs over inward (toward a center axis line side of the cold-cathode tube 17) from the inner surface in the leading end portion of the arm portion 34, and is located at a position at which the cold-cathode tube 17 is covered from the front side (light outgoing side), that is, the retaining projection 36 is located on the side in the direction in which the cold-cathode tube 17 drops out of. In the mounted state, the cold-cathode tube 17 is supported at three points, that is, a central first support point located immediately below the center of the cold-cathode tube 17 in the bottom surface of the lamp gripping portion 28 and second and third support points located at inner ends of the retaining projections 39. Between the support points, a slight gap (clearance) extending in the circumferential direction is provided between the outer circumference surface of the cold-cathode tube 17 and the inner circumference surface of the lamp gripping portion 28.

Guide portions 37 are provided in the outer surfaces in the leading end portions of the arm portions 34 in order to guide the operation to mount the cold-cathode tube 17. Each guide portion 37 is formed into a tapered shape while rising obliquely outward from the arm portion 34. The guide portions 37 have gradients from projection base ends to projection leading ends so as to be separated from each other. In addition, in the guide portions 40, the inner surfaces opposite to the cold-cathode tube 17 are formed into inclined surfaces having the similar gradients. Accordingly, an interval between the inner surfaces that are of surfaces opposite to each other in the guide portions 37 is gradually narrowed downward in the FIG., that is, in the direction in which the cold-cathode tube 17 is mounted, and the interval is gradually widened in the direction in which the cold-cathode tube 17 is detached. Therefore, the operation to mount the cold-cathode tube 17 can smoothly be guided by the inner surfaces of the guide portions 37. The inner surface of the guide portion 37 continues directly and smoothly into the inner surface of the retaining projection 36.

Next, the support pin 29 constituting the support structure for the diffuser plate 15a will be described in detail. As illustrated in FIG. 5, the support pin 29 is disposed in the substantially center in the short-side direction of the main body 27, and a dimension in the X-axis direction of the support pin 29 is set larger than that of the lamp gripping portion 28 while being set smaller than that the main body 27. As illustrated in FIG. 9, the support pin 29 supports a portion of the diffuser plate 15a, which is located closer onto the screen central side than an outer peripheral edge portion supported by the holder 20 and the like, from the backside. This allows the diffuser plate 15a to be controlled so as not to bend or warp onto the side of the cold-cathode tube 17. The support pin 29 has a circular section when being cut along the horizontal direction (FIG. 5), and is formed into a tapered shape in which a diameter dimension decreases gradually toward the leading end side from the root side. That is, the support pin 29 is formed into a substantially conical shape. An R surface is formed to round the support pin 29 in the leading end portion of the support pin 29 that can abut on the diffuser plate 15a. A projection height of the support pin 29 from the main body 27 is set higher than the lamp gripping portion 28, whereby the support pin 29 becomes a region projected to the highest position in the lamp clip 18. Accordingly, in mounting/removing the lamp clip 18 on/from the chassis 14, a worker can perform the work while gripping the support pin 29, and the support pin 29 can also act as manipulating portion during the mounting/removing operation.

A detailed description will then be given of the mounting portions 30 and 31 constituting the retaining structure of the lamp clip 18 for the chassis 14 along with the mounting holes 32 and 33 in the chassis 14. First the retaining structure will briefly be described. As illustrated in FIG. 9, the mounting portions 30 and 31 are formed into hook shapes along the rear surface (plate surface) of the main body 27, and the mounting portions 30 and 31 are inserted in the mounting holes 32 and 33 of the chassis 14 and the insertion holes 34 and 35 of the reflecting sheet 23 and projected to the backside of the chassis 14. At this point, the lamp clip 18 is slid along the length direction (Y-axis direction, direction of the bottom plate surfaces of the reflecting sheet 23 and chassis 14) of the main body 27, which allows the chassis 14 to be retained while sandwiched between the mounting portions 30 and 31 and the main body 27.

The first mounting portion 30 and the second mounting portion 31 have a common structure. The common structure will be described below. The first mounting portion 30 and the second mounting portion 31 include base portions 30a and 31a that are projected from a rear surface of the main body 27 and cantilever projections 30b and 31b that are projected (extended) along the long-side direction of the main body 27 while bent at a substantially right angle from leading ends of base portions 30a and 31a, respectively. The first mounting portion 30 and the second mounting portion 31 are formed into a substantially L-shape when viewed from the front face. The width dimensions and length dimensions of the first mounting portion 30 and second mounting portion 31 are set so as to be smaller than the short-side dimension and long-side dimension of the main body 27.

A difference of the structure between the first mounting portion 30 and the second mounting portion 31 will be described below. The guide portion 38 that can guide the operation to be mounted on the chassis 14 is provided at leading end of the projection 30b of the first mounting portion 30. The guide portion 38 is formed with a gradient that is away from the main body 27 toward the leading end side. A latching projection 39 that is projected toward the side of the main body 27 from leading end of the projection 31b of the second mounting portion 31 is provided. A tapered surface of the latching projection 39 is formed in a surface opposite to the main body 27. A surface of the latching projection 39 opposite to the base portion 31a in erects in substantially parallel with the outer surface of the base portion 31a and forms a substantially straight surface along the direction (Z-axis direction) orthogonal to the direction (Y-axis direction) in which the lamp clip 18 is slid to the chassis 14, thereby becoming a latching surface for the chassis 14.

The first mounting hole 32 and the second mounting hole 33, which are made in the chassis 14, will be described below. The first mounting hole 32 and the second mounting hole 33 are formed into a size that permits the insertion of the corresponding first mounting portion 30 and second mounting portion 31. More specifically, the first mounting hole 32 and the second mounting hole 33 are formed into rectangular shapes according to the first mounting portion 30 and the second mounting portion 31 when viewed from above, and the length dimensions and width dimensions of the first mounting hole 32 and second mounting hole 33 are smaller than those of the main body 27. Accordingly, in the state with the lamp clip 18 being mounted, the first mounting hole 32 and the second mounting hole 33 are closed by the main body 27. A latching hole 40 in which the latching projection 39 can be latched is made in the chassis 14 at the position adjacent to the second mounting hole 33. The latching hole 40 is made on the right with respect to the second mounting hole 33 as illustrated in FIG. 9, that is, the latching hole 43 is made at the position deviated in the direction in which the projection 31b is projected (slide direction associated with the mounting). Similarly to the first mounting hole 32 and the second mounting hole 33, the size of the latching hole 40 is smaller than that of the main body 27 when viewed from above, and the latching hole 43 is closed by the main body 27 during the mounted state.

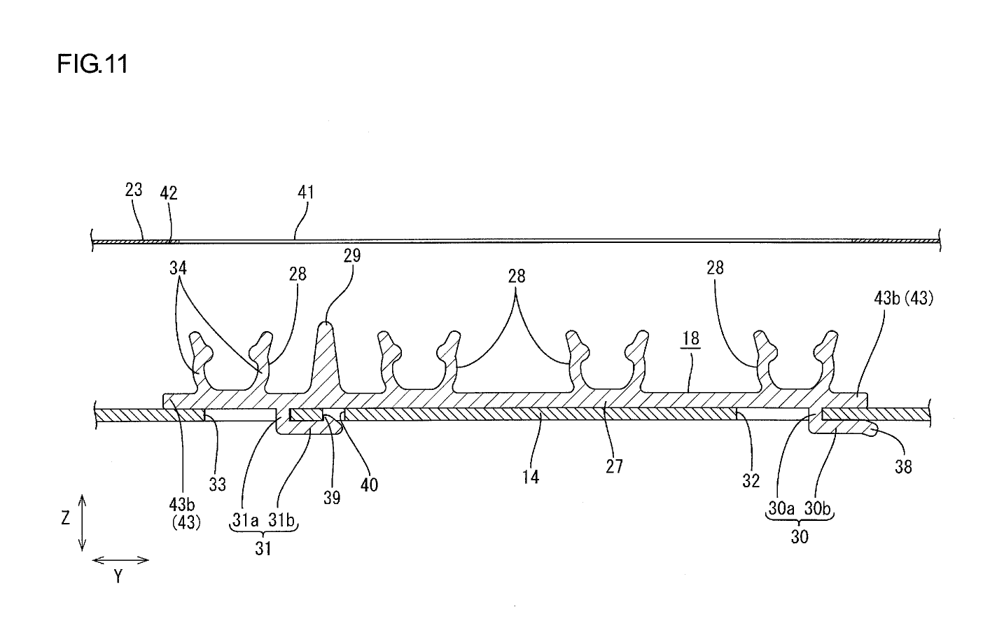

In the present embodiment, the reflecting sheet 23 is attached from the front side of the lamp clip 18 while the lamp clips 18 are mounted on the chassis 14 (FIG. 11). Correspondingly, as illustrated in FIG. 9, an opening 41 is provided in the reflecting sheet 23. The lamp gripping portions 28 and the support pin 29 can be passed through the opening 41, and the lamp gripping portions 28 and the support pin 29 are of the portions that are projected toward the front side from the main body 27 of the lamp clip 18. An inner edge portion 42 of the opening 41 of the reflecting sheet 23 covers an outer edge portion 43 of the main body 27 from the front.

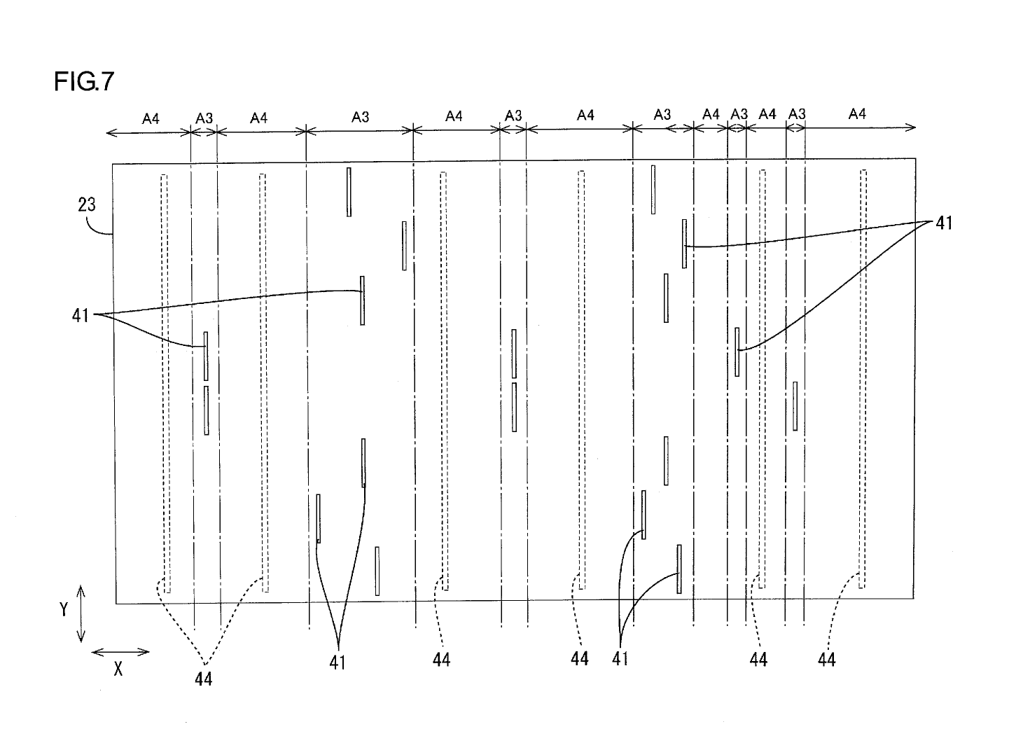

As described above, the reflecting sheet 23 has a size in which the substantially whole area of the inner surface of the bottom plate that is of the portion, on which the lamp clip 18 is mounted in the chassis 14. As illustrated in FIG. 7, the reflecting sheet 23 has a plurality of openings 41 arranged in the dispersed manner in the X-axis direction and the Y-axis direction at positions corresponding to positions at which the lamp clips 18 are mounted to the chassis 14. Therefore, each opening 41 is aligned with each lamp clip 18 mounted on the chassis 14 when the reflecting sheet 23 is assembled in the chassis 14. Because the arrangement of each opening 41 is aligned with the arrangement of each lamp clip 18, a formation region A3 where the opening 41 is formed and a non-formation A4 where the opening 41 is not formed corresponds to the mounting region A1 and non-mounting region A2 of the lamp clip 18 in the chassis 14. Each of the formation region A3 and the non-formation A4 has a predetermined width in the long-side direction (axis direction of the cold-cathode tube 17) of the reflecting sheet 23 and is formed into a strip shape extended along the short-side direction (direction in which the cold-cathode tubes 17 are arrayed) of the reflecting sheet 23. The formation regions A3 and the non-formations A4 are alternately arrayed in the long-side direction of the reflecting sheet 23. Because the arrangement of each opening 41 is similar to that of each lamp clip 18, the detailed description is omitted.

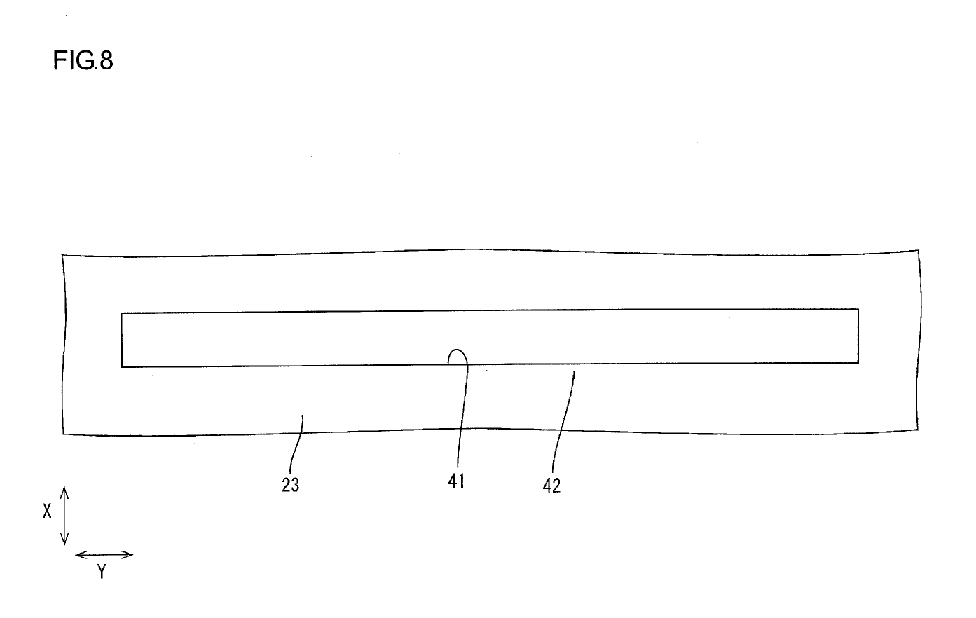

As illustrated in FIG. 8, similarly to the main body 27 of the lamp clip 18, the opening 41 is formed into the elongated rectangular shape along the Y-axis direction when viewed from above, and the size thereof is smaller than that of the main body 27. More specifically, a long-side dimension (dimension in the Y-axis direction) of the opening 41 is smaller than that of the main body 27, and a short-side dimension (dimension in the X-axis direction) of the opening 41 is smaller than that of the main body 27. In other words, the opening 41 is formed so as to become smaller than the main body 27 with respect to planar sizes along the X-axis and Y-axis. The difference in size between the opening 41 and the main body 27 is set larger than an assumed maximum value of an amount of position deviation that is generated between both sides when the reflecting sheet 23 is assembled in the chassis 14. Therefore, the outer edge portion 43 of the main body 27 is securely covered with the inner edge portion 42 of the opening 41.

A width dimension (opening width), that is, the dimension in the X-axis direction of the opening 41 is set so as to be equal to or slightly larger than the dimension in the X-axis direction of the support pin 29. As described above, the dimension in the X-axis direction of the support pin 29 is larger than the dimension in the X-axis direction of the lamp gripping portion 28. On the other hand, a length dimension (opening length), that is, the dimension in the Y-axis direction of the opening 41 is larger than a distance between the arm portions 34 on end sides of the lamp gripping portions 28 located at both end positions. Accordingly, in assembling the reflecting sheet 23, the lamp gripping portions 28 and the support pin 29 are collectively passed through the opening 41.

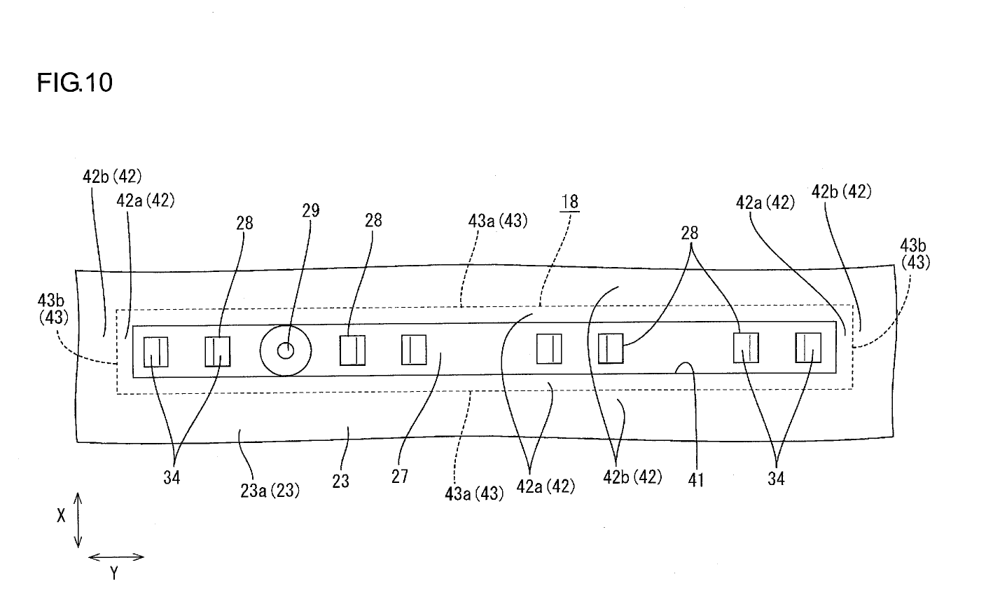

When the reflecting sheet 23 is attached as illustrated in FIGS. 9 and 10, the whole outer edge portion 43 of the main body 27 is covered in a seamless manner with the inner edge portion 42 of the opening 41 of the reflecting sheet 23. More specifically, the entire long-side outer edge portions 43a and the entire short-side outer edge portions 43b of the outer edge portion 43 of the main body 27 are covered with the long-side inner edge portions and the short-side inner edge portions of the opening 41 of the reflecting sheet 23 from the front. The inner edge portion 42 of the opening 41 of the reflecting sheet 23 covers the outer edge portion 43 of the main body 27. It has a frame shape with a substantially constant width. The inner edge portion 42 corresponds to an outer edge covered portion of the lamp clip 18.

When the reflecting sheet 23 is attached, while the most part of the reflecting sheet 23 except the inner edge portion 42 of each opening 41 constitutes a laying portion 23a that is laid on the inner surface of the chassis 23, the inner edge portion 42 of each opening 41 of the reflecting sheet 23 includes an overlapping portion 42a that runs over the outer edge portion 43 of the main body 27 to overlap the front side. The overlapping portion 42a is formed into the frame shape that is parallel to the outer edge portion 43 of the main body 27 when viewed from above. Accordingly, in the reflecting sheet 23, a difference in thickness corresponding to the thickness of the main body 27 in the Z-axis direction is generated between the overlapping portion 42a and the laying portion 23a with respect to the chassis 14. In the reflecting sheet 23, a portion located between the overlapping portion 42a and the laying portion 23a with respect to the chassis 14 constitutes an inclined portion 42b having a rising slope from the laying portion 23a toward the overlapping portion 42a. In other words, the inclined portion 42b is formed to be spread out from the overlapping portion 42a toward the laying portion 23a with respect to the chassis 14. The overlapping portion 42a and the laying portion 23a with respect to the chassis 14 are connected in a slope manner by the inclined portion 42b, thereby eliminating a step. A gap having a substantially triangular shape in section is provided between the inclined portion 42b and the outer circumference end surface in the outer circumference edge 43 of the main body 27. The inclined portion 42b is formed into the frame shape that further surrounds the overlapping portion 42a from the outside when viewed from above, and the outer circumference end surface at the outer circumference edge 43 of the main body 27 and the outside portion in the chassis 14 are covered over the whole circumference with the inclined portion 42b.

When the reflecting sheet 23 is attached, the lamp gripping portions 28 and the support pin 29 provided on the main body 27 are all inserted in the opening 41. Accordingly, the adjacent lamp gripping portions 28 face each other without the reflecting sheet 23 therebetween. Moreover, the lamp gripping portion 28 and the adjacent support pin 29 face each other without the reflecting sheet 23 therebetween.

In the present embodiment, the reflecting sheet 23 is not sandwiched between the chassis 14 and the main body 27 of the lamp clip 18. Correspondingly, in the present embodiment, a double-sided adhesive tape 44 is used to fix the reflecting sheet 23 to the chassis 14. In the configuration of the double-sided adhesive tape 44, adhesive agents (not illustrated) are disposed in both the front and the rear surfaces of a base material (not illustrated) that is formed into a strip shape having a predetermined width. As illustrated in FIGS. 3 and 4, the double-sided adhesive tape 44 is placed between the reflecting sheet 23 and the chassis 14, and adhesive layers of the double-sided adhesive tape 44 are adhered to surfaces opposite to each other of the reflecting sheet 23 and chassis 14, which allows the reflecting sheet 23 to be fixed to the chassis 14.

As illustrated in FIGS. 6 and 7, the double-sided adhesive tapes 44 are selectively disposed in the non-mounting region A2 of the lamp clip 18 in the chassis 14 and the non-formation region A4 of the opening 41 in the reflecting sheet 23. The double-sided adhesive tape 44 is extended along the short-side directions (the direction in which the cold-cathode tubes 17 are arrayed) of the chassis 14 and reflecting sheet 23, and a length dimension thereof is substantially equal to or shorter than the short-side dimensions of the chassis 14 and reflecting sheet 23. That is, because the double-sided adhesive tape 44 does not traverse the mounting region Al of the lamp clip 18 in the chassis 14 and the formation region A3 of the opening 41 in the reflecting sheet 23, it is not necessary to divide the double-sided adhesive tape 44 into pieces to be adhered to the reflecting sheet 23 or the chassis 14. As a consequence, this configuration is excellent in the workability.

Action of the present embodiment having the above-described structure will be described below. The liquid crystal panel 11 and the backlight device 12 are separately produced and assembled in each other using the bezel 13 or the like, thereby producing the liquid crystal display device 10 shown in FIGS. 3 and 4. A detailed description will be given of the work that assembles the backlight device 12, particularly, the work that mounts the lamp clip 18 and the reflecting sheet 23 on the chassis 14.

The work of mounting each lamp clip 18 on the chassis 14 is performed in advance of the assembly of the reflecting sheet 23. A worker grips the support pin 29 of the lamp clip 18, and pushes the mounting portions 30 and 31 into the bottom plate of the chassis 14 while aligned with the mounting holes 32 and 33. Therefore, the mounting portions 30 and 31 are inserted in the mounting holes 32 and 33. The surface on the backside of the main body 27 abuts on the surface of the chassis 14, and whereby the projections 30b and 31b are projected from the backside of the chassis 14. Then the lamp clip 18 is slid in the direction in which the projections 30b and 31b are projected (the right illustrated in FIG. 11). Therefore, the latching projection 39 runs over the rear surface of the chassis 14 in midstream, whereby tentatively the projection 31b of the second mounting portions 31 is elastically deformed. When the lamp clip 18 is slid to a regular position, as illustrated in FIG. 11, the projection 31b of the second mounting portion 31 is restored, the latching projection 39 proceeds in the latching hole 40, and a latching surface of the latching projection 39 is latched in a circumferential surface of the latching hole 40, thereby controlling careless movement of the lamp clip 18 in the detaching direction. At this point, peripheral edge portions of the mounting holes 32 and 33 are retained while sandwiched between the main body 27 and the projections 30b and 31b of the mounting portions 30 and 31. Therefore, the lamp clip 18 is held to the chassis 14.

The work that assembles the reflecting sheet 23 in the chassis 14 is performed after the lamp clip 18 is completely mounted on the chassis 14 in the above-described manner. In advance of the assembly of the reflecting sheet 23, the double-sided adhesive tape 44 is adhered to the surface (surface opposite to the chassis 14) on the backside of the reflecting sheet 23. At this point, as illustrated in FIG. 7, when the double-sided adhesive tape 44 is adhered to the non-formation region A4 of the opening 41 in the reflecting sheet 23 while being extended along the short-side direction of the reflecting sheet 23, the double-sided adhesive tape 44 is restricted from traversing the formation region A3 of the opening 41 in the process of adhesion. Accordingly, this configuration is excellent in the workability, because the double-sided adhesive tape 44 can be adhered to the reflecting sheet 23 over the substantially total length in the short-side direction without cutting the double-sided adhesive tape 44 in midstream. The double-sided adhesive tape 44 may be adhered not to the side of the reflecting sheet 23 but to the side of the chassis 14. In such cases, the similar effect can be obtained when the double-sided adhesive tape 44 is adhered to the non-mounting region A2 of the lamp clip 18 in the chassis 14.

The reflecting sheet 23 is adhered to the chassis 14 after the double-sided adhesive tape 44 is adhered to the non-formation region A4 in the reflecting sheet 23. As illustrated in FIG. 11, the chassis 14 is overlaid with the reflecting sheet 23 from the front side of the chassis 14 while each opening 41 in the reflecting sheet 23 is positioned in the lamp clip 18 mounted on the chassis 14. Therefore, the lamp gripping portions 28 and support pin 29, which are projected toward the front side from the main body 27 in each lamp clip 18, are passed through each opening 41. At this point, the lamp gripping portions 28 and support pin 29 in the corresponding lamp clip 18 are collectively passed through the opening 41 (FIG. 10). Because the inner edge portion 42 of the opening 41 in the reflecting sheet 23 does not proceed between the adjacent lamp gripping portions 28 or between the lamp gripping portion 28 and support pin 29 which are adjacent to each other, the lamp gripping portion 28 or the support pin 29 is hardly hooked in the inner edge portion 42 of the opening 41. Therefore, this configuration is excellent in the assembly workability of the reflecting sheet 23.

After the lamp gripping portions 28 and the support pin 29 are passed through the opening 41, the outer edge portion 43 of the main body 27 is covered with the inner edge portion 42 of the opening 41. When the most part of the reflecting sheet 23 abuts on the inner surface of the bottom plate of the chassis 14, as illustrated in FIG. 9, the portion that is disposed outside the overlapping portion 42a running over the outer edge portion 43 of the main body 27 in the inner edge portion 42 of the opening 41 forms the inclined portion 42b having the spread-out shape between the overlapping portion 42a and the laying portion 23a with respect to the chassis 14 while pulled between the overlapping portion 42a and the laying portion 23a. Therefore, as illustrated in FIG. 10, the entire outer edge portion 43 of the main body 27 with the inner edge portion 42 of the opening 41. At this point, the adhesive layer on the backside of each double-sided adhesive tape 44 is adhered to the inner surface of the bottom plate of the chassis 14, whereby the reflecting sheet 23 is fixed to the chassis 14.

After reflecting sheet 23 is attached in the above-described way, the cold-cathode tube 17 is mounted on each lamp gripping portion 28 of the lamp clip 18, and the holder 20 is mounted. Then, when the diffuser plate 15a and the optical sheet 15b are placed while stacked, the liquid crystal panel 11 is placed from the front side, and the bezel 13 is assembled to assemble the liquid crystal display device 10.

The action in lighting each cold-cathode tube 17 in the backlight device 12 will be described below. As illustrated in FIG. 9, the diffuser plate 15a is directly illuminated with linear light emitted from each cold-cathode tube 17, or is indirectly illuminated with the linear light after the linear light is reflected from the reflecting sheet 23 or the lamp clip 18. At the same time, the linear light is converted into planar light in a process of passing through the diffuser plate 15a and the optical sheet 15b, and the planar light illuminates the liquid crystal panel 11.

Because the lamp clip 18 mounted on the chassis 14 includes the main body 27 having the predetermined thickness, a step is generated between the chassis 14 and the outer edge portion 43 of the main body 27. Therefore, assuming that the outer edge portion 43 of the main body 27 is exposed to the side of the diffuser plate 15a, an outer circumference end surface of the outer edge portion 43 and a portion surrounding thereof are hardly illuminated with the light emitted from the cold-cathode tube 17, thereby easily generating a shadow. On the other hand, in the present embodiment, because the outer edge portion 43 of the main body 27 is covered from the front side with the inner edge portion 42 of the opening 41 in the reflecting sheet 23, the shadow is hardly generated by the outer edge portion 43 of the main body 27. More specifically, the inner edge portion 42 of the opening 41 includes the overlapping portion 42a that runs over and overlaps the outer edge portion 43 of the main body 27 and the inclined portion 42b that is spread out from the overlapping portion 42a toward the laying portion 23a, and covers the outer edge portion 43 of the main body 27 over the whole circumference. This rarely generates the region that is hardly illuminated with the light emitted from the cold-cathode tube 17. In other words, because the laying portion 23a, overlapping portion 42a, and inclined portion 42b in the reflecting sheet 23 are substantially evenly illuminated with the light emitted from the cold-cathode tube 17, the shadow is hardly generated compared with the case in which the outer edge portion 43 of the main body 27 is exposed to the side of the diffuser plate 15a. Therefore, the luminance unevenness is less likely to occur in the backlight device 12.

In the present embodiment, the outer edge portion 43 of the main body 27 in the lamp clip 18 is covered with the reflecting sheet 23, thereby taking the countermeasure for the luminance unevenness. On the other hand, when the countermeasure for the luminance unevenness is taken by devising the shape of the lamp clip like the conventional technology, the cost increases caused by the need of newly producing the lamp clip having the special structure and the need of exchanging the lamp clip from the general-purpose product arise. On the other hand, in the present embodiment, although the need of forming the opening 41 in the reflecting sheet 23 arises, only one component that is of the reflecting sheet 23 is subjected to the processing. In addition, the processing is also performed at low cost, and the general-purpose product conventionally used can directly be used as the lamp clip 18. Therefore, this configuration can be dealt with at low cost as a whole.

Additionally, in the present embodiment, a ratio of a surface area of the whole lamp clip 18 to a surface area of the reflecting sheet 23 lowers by the portion in which each lamp clip 18 is covered with the reflecting sheet 23. For example, when the lamp clip 18 is lower than the reflecting sheet 23 in reflectance, the lamp clip 18 is easily visually recognized as darker than the reflecting sheet 23, so that the lamp clip 18 tends to be easily visually recognized as a dark portion with increasing the ratio of the surface area of the lamp clip 18. On the other hand, in the present embodiment, the ratio of the surface area of the whole reflecting sheet 23 to the surface area of the lamp clip 18 can be increased by the area in which each lamp clip 18 is covered with the reflecting sheet 23. Therefore, the luminance unevenness is less likely to occur in the backlight device 12 even if the reflectivity of the lamp clip 18 is lower than that of the reflecting sheet 23. As used herein, the “surface area” means an area of a portion in which the reflecting sheet 23 or the lamp clip 18 is exposed to the cold-cathode tube 17 or the diffuser plate 15a.

As described above, according to the present embodiment, the backlight device 12 includes the chassis 14, the cold-cathode tube 17 disposed in the chassis 14, the main body 27 mounted on the chassis 14, the lamp clip 18 having the lamp gripping portion 28 and the reflecting sheet 23 disposed in the chassis 14. The lamp clip 18 is provided on the main body 27 so as to grip the cold-cathode tube 17. The reflecting sheet 23 has the opening 41 through which the lamp gripping portion 28 is passed and inner edge portion thereof covers the outer edge portion of the main body 27.

Because the outer edge portion 43 of the main body 27 is covered with the inner edge portion 42 of the opening 41 while the lamp gripping portion 28 that grips the lamp in the lamp clip 18 is passed through the opening 41 of the reflecting sheet 23, the outer edge portion 43 that forms the step between the chassis 14 and the outer edge portion 43 in the main body 27 can be hardly visually recognized as the shadow. In the present embodiment, the reflecting sheet restricts the generation of the shadow in the outer edge portion 43 of the main body 27, so that the general-purpose product can be used as the lamp clip 18. Therefore this configuration achieves the cost reduction. Additionally, because the lamp clip 18 is covered with the reflecting sheet 23, the ratio of the surface area of the lamp clip 18 to the surface area of the reflecting sheet 23 is decreased. Therefore, the luminance unevenness is less likely to occur even if the lamp clip 18 and the reflecting sheet 23 have different reflection efficiencies. Therefore, this configuration is suitable to the thinner liquid crystal display device.

The main body 27 is formed into the rectangular shape, and at least the long-side v portion 43a in the outer edge portion 43 of the main body 27 is covered with the inner edge portion 42 of the opening 41 in the reflecting sheet 23. Because the long-side outer edge portion 43 in the outer edge portion 43 of the rectangular main body 27 is a region where the shadow is easily noticeable compared with the short-side outer edge portion 43b, at least the long-side outer edge portion 43a is covered with the of the inner edge portion 42 of the opening 41 in the reflecting sheet 23. Therefore, the luminance unevenness is further effectively reduced.

The outer edge portion 43 of the main body 27 is covered over the whole circumference with the inner edge portion 43 of the opening 41 in the reflecting sheet 23. Because the outer edge portion 43 of the main body 27 is less likely to be visually recognized as the shadow, the luminance unevenness is very effectively reduced.

The plurality of lamp gripping portions 28 are provided on the main body 27 and all inserted in the opening 41. Therefore, when the lamp gripping portions 28 are passed through the opening 41 in assembling the reflecting sheet 23, the lamp gripping portions 28 are hardly hooked in the reflecting sheet 23. Consequently, this configuration is excellent in the assembly workability of the reflecting sheet 23.

The support pin 29 that can support the diffuser plate 15a is provided in the main body 27 while the diffuser plate 15a is disposed at the position at which the cold-cathode tube 17 is sandwiched between the diffuser plate 15a and the chassis 14, and the support pin 29 is passed through the opening 41. Therefore, when the reflecting sheet 23 is assembled, the support pin 29 is passed through the opening 41. The diffuser plate 15a can be supported well by the support pin 29.

The opening 41 surrounds the lamp gripping portions 28 and the support pin 29 collectively. Therefore, when the lamp gripping portions 28 and the support pin 29 are passed through the opening 41 in assembling the reflecting sheet 23, the lamp gripping portions 28 and the support pin 29 are hardly hooked in the reflecting sheet 23. This configuration is excellent in the assembly workability of the reflecting sheet 23.

The diffuser plate 15a is disposed such that the cold-cathode tube 17 is sandwiched between the diffuser plate 15a and the chassis 14. The support pin 29 that supports the diffuser plate 15a and a plurality of the lamp gripping portions 28 are provided on the main body 27. The support pin 29 is passed through the opening 41. The lamp gripping portions 28 and the support pin 29 are all inserted in the opening 41. Therefore, when the lamp gripping portions 28 and the support pin 29 are passed through the opening 41 in assembling the reflecting sheet 23, the lamp gripping portions 28 and the support pin 29 are hardly hooked in the reflecting sheet 23. As a consequence, this configuration is further excellent in the assembly workability of the reflecting sheet 23.

The opening 41 has the width that is constant over the total length. The width measures in the direction perpendicular to the direction in which the lamp gripping portions 28 and the support pin 29 are aligned. Namely, the shape of the opening 41 is simple and thus the inner edge portion 42 of the opening 41 is less likely to be deformed.

The double-sided adhesive tape 44 is included in order to fix the reflecting sheet 23 to the chassis 14. When the outer edge portion 43 of the main body 27 is covered with the inner edge portion 42 of the opening 41 of the reflecting sheet 23, the reflecting sheet 23 is hardly fixed by the lamp clip 18. However, according to the configuration described above, because the reflecting sheet 23 can be fixed to the chassis 14 by the double-sided adhesive tape 44, this configuration can maintain the state in which the outer edge portion 43 of the main body 27 is covered with the inner edge portion 42 of the opening 41. Additionally, this configuration is suitable to the cost reduction.

A plurality of the lamp clips 18 are mounted on the chassis 14 and the reflecting sheet 23 has a plurality of the openings 41 at the positions corresponding to the lamp clips 18. The outer edge portions 43 of the main bodies 27 of the multiple lamp clips 18 are covered with a single reflecting sheet 23. In comparison to an illuminating device in which a reflecting sheet is used for each lamp clip, better assembly workability at a low cost. Additionally, this configuration is extremely excellent in the assembly workability because the substantially whole area of the chassis 14 is covered with the reflecting sheet 23.

In the cold-cathode tube 17 used in the present embodiment, the tube diameter is set to 4.0 mm, the distance between the cold-cathode tube 17 and the reflecting sheet 23 is set to 0.8 mm, the distance between the adjacent cold-cathode tubes 17 is set to 16.4 mm, and the distance between the cold-cathode tube 17 and the diffuser plate 15a is set to 2.7 mm. In the backlight device 12, the distance between the constituents decreases to achieve a thinner device, particularly the distance between the cold-cathode tube 17 and the diffuser plate 15a and the distance between the cold-cathode tube 17 and the reflecting sheet 23 decrease. Using the thinner backlight device 12, the thickness (that is, the thickness from the surface of the liquid crystal panel 11 to the rear surface of the backlight device 12) of the liquid crystal display device 10 can be set to 16 mm, and the thickness (that is, the thickness from the surface of the front-side cabinet Ca to the rear surface of the backside cabinet Cb) of the television receiver TV can be set to 34 mm, thereby implementing the flat-screen television receiver.

### Second Embodiment

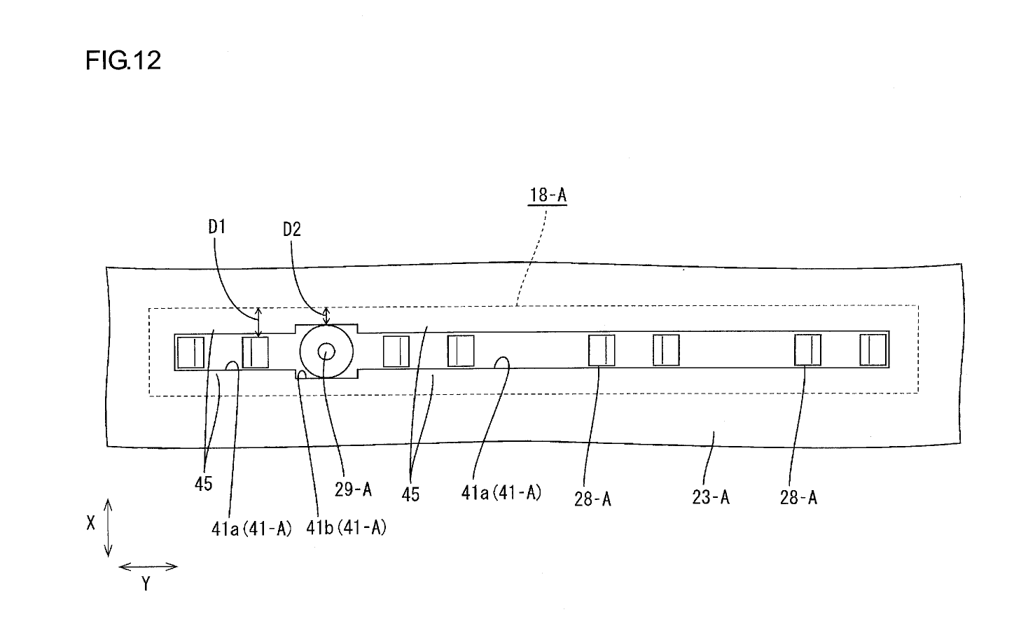

A second embodiment of the invention will be described with reference to FIG. 12. In the second embodiment, a shape of an opening 41-A is changed unlike that of the first embodiment. In the second embodiment, the parts having the same names as the first embodiment are indicated by the same numeral, and a suffix “-A” is added to the end of each numeral. The same structure, functions and effects will not be described.

As illustrated in FIG. 12, a lamp gripping portion 28-A in a lamp clip 18-A is smaller than a support pin 29-A in a dimension in the X-axis direction (the direction orthogonal to the direction in which the lamp gripping portions 28-A and the support pin 29-A are arrayed). This means that, in the X-axis direction, the a distance D1 from an outer edge of the lamp gripping portion 28-A to an outer edge of a main body 27-A is larger than a distance D2 from an outer edge of a support pin 29-A to the outer edge of the main body 27-A. Correspondingly, an opening 41-A of a reflecting sheet 23-A has a portion 45a through which the lamp gripping portion 28-A is passed and a part 41b through which the support pin 29-A is passed. The width of the portion 45a is different from the width of the part 41b. The widths measure in the X-axis direction. Specifically, the width of the portion 45a through which the lamp gripping portion 28-A is passed that is larger than that of the part 41b through which the support pin 29-A is passed. Therefore, the inner edge of the opening 41-A is located close to the outer circumference surface of each lamp gripping portion 28-A or the support pin 29-A. That is, an extended portion 45 that is partially extended inward is provided in an inner edge portion 42-A of the opening 41-A, and each extended portion 45 is disposed at a position at which the dimension in the X-axis direction corresponds to each lamp gripping portion 28-A that is relatively smaller than the support pin 29-A. Therefore, compared with the first embodiment, this configuration further increase the covered area of the reflecting sheet 23-A with respect to the lamp clip 18-A, and this becomes further effective as the countermeasure for the luminance unevenness.

As described above, according to the present embodiment, the lamp gripping portions 28-A and the support pin 29-A are provided such that the distance D1 from the outer edge of the of the lamp gripping portion 28-A to the outer end of the main body 27-A differs from the distance D2 from the outer edge of the support pin 29-A to the outer edge of the main body 27-A. The distances D1 and D2 measure in the direction perpendicular to the direction in which the lamp gripping portion 28-A and the support pin 29-A are aligned. In addition, the opening 41-A has a part 41a having a small with and a part 41b having a large width. One of the lamp gripping portion 28-A and the support pin 29-A, whichever the distance to the outer edge of the main body 27-A is smaller, is passed through the part 41b having the large width. The other one, the distance from which to the outer edge of the main body 27-A is larger, is passed through the part 41a having the small width. Even if the lamp gripping portion 28-A and the support pin 29-A have different sizes that measure in the direction perpendicular to the direction in which the lamp gripping portions 28-A and the support pin 29-A are aligned, the areas of the lamp clip 18-A covered with the reflecting sheet 23-A can be increased by forming the opening 41-A with different widths corresponding to the sizes of the lamp gripping portions 28-A and support pin 29-A. Therefore, even if the lamp clip 18-A differs from the reflecting sheet 23-A in the reflection efficiency. Therefore, the luminance unevenness is further less likely to occur.

### Third Embodiment

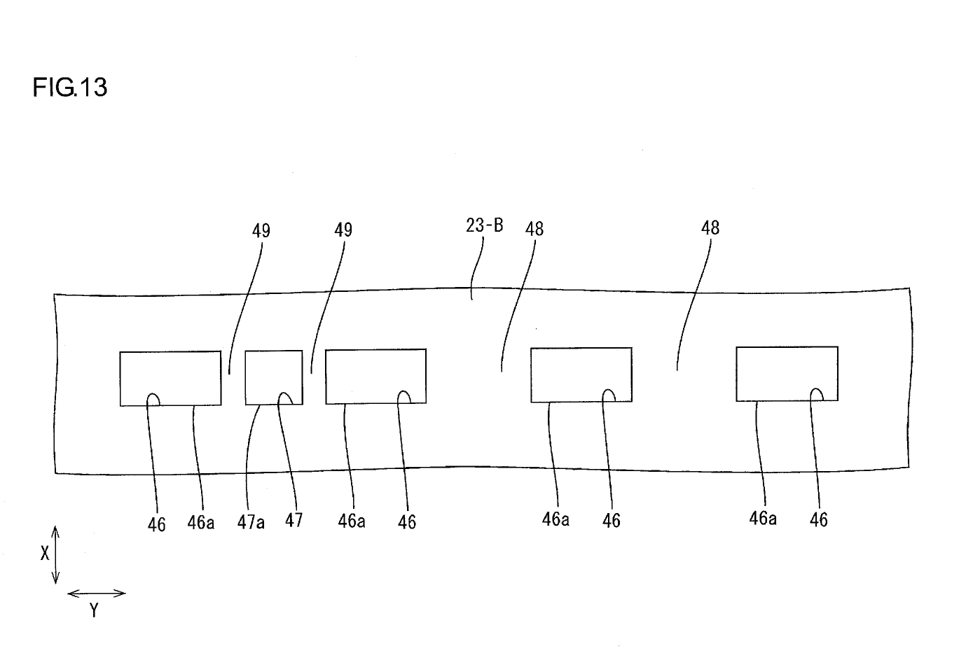

A third embodiment of the present invention will be described with reference to FIGS. 13 to 16. In the third embodiment, an opening is provided for each lamp gripping portion or support pin. In the third embodiment, the parts having the same names as the first embodiment are indicated by the same numerals, and a suffix “-B” is added to the end of each numeral. The structures, functions and effects will not be described.

As illustrated in FIG. 13, the reflecting sheet 23-B has a plurality of openings 46, 47 for respective lamp gripping portions 28-B and a support pin 29-B on a lamp clip 18-B. Five openings 46, 47 are linearly formed in parallel along the Y-axis direction at positions corresponding to the lamp clip 18-B in the reflecting sheet 23-B. The openings 46, 47 are provided such that the lamp gripping portion 28-B is passed through the opening 46 for a lamp gripping portion and the support pin 29-B is passed through the opening 47 for a support pin, and the openings 46, 47 are disposed according to the arrangement of the lamp gripping portions 28-B and support pin 29-B in the lamp clip 18-B. Accordingly, the four openings 46 are arranged at substantially symmetrical positions, and the opening 47 is provided at the position that is eccentric with respect to the symmetrical center of each opening 46. The sizes in the X-axis direction of the openings 46, 47 are substantially equal to or larger than the size of the support pin 29-B that is larger than the lamp gripping portion 28-B, and all the openings 46, 47 have the same size. On the other hand, the sizes in the Y-axis direction of the openings 46, 47 are substantially equal to or larger than the sizes of the corresponding lamp gripping portion 28-B or support pin 29-B.

The reflecting sheet 23-B partially remains between the adjacent openings 46, 47. The partially remaining reflecting sheet 23-B includes covering portions 48 and 49 that covers the middle portion of a main body 27-B between the lamp gripping portions 28-B and the middle portion of the main body 27-B between the lamp gripping portion 28-B and the support pin 29-B. Specifically, the reflecting sheet 23-B remaining between the adjacent openings 46 includes the first covering portion 48 that covers the middle portion of the main body 27-B between the adjacent lamp gripping portions 28-B. The first covering portion 48 is formed so as to be substantially equal to or smaller than an interval between the adjacent lamp gripping portions 28-B in the Y-axis direction. On the other hand, the reflecting sheet 23-B remaining between the opening 46 and the adjacent opening 47 includes the second covering portion 49 that covers the middle portion of the main body 27-B between the lamp gripping portion 28-B and the adjacent support pin 29-B. The second covering portion 49 is formed so as to be substantially equal to or smaller than an interval between the lamp gripping portion 28-B and support pin 29-B which are adjacent to each other in the Y-axis direction, and so as to be smaller than the first covering portion 48.

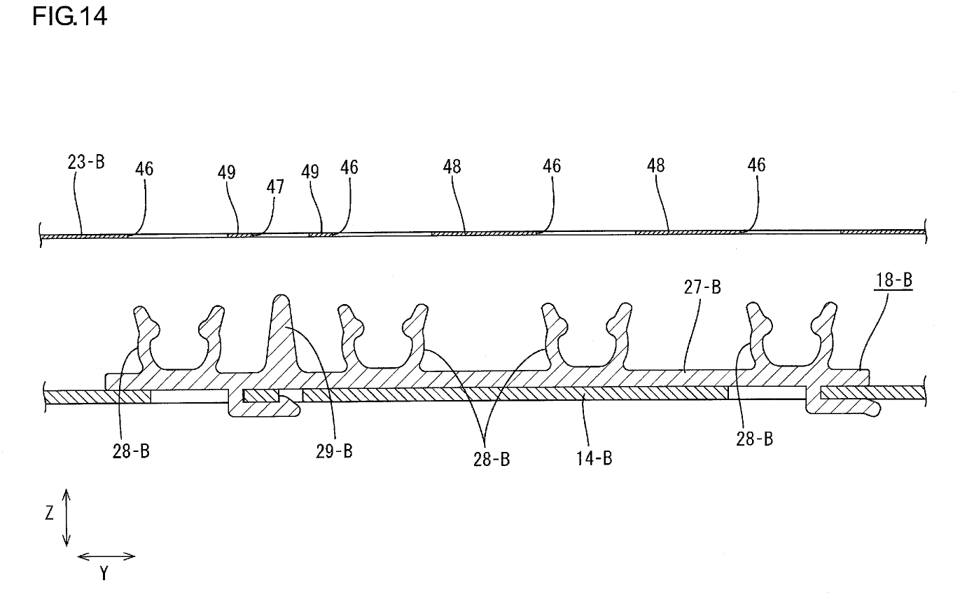

When the reflecting sheet 23-B is assembled in the chassis 14-B after the lamp clips 18-B are mounted on the chassis 14-B, the following procedure is performed. That is, as illustrated in FIG. 14, in the state in which each opening 46 in the reflecting sheet 23-B is positioned in the corresponding lamp gripping portion 28-B while the opening 47 is positioned in the support pin 29-B, the reflecting sheet 23-B is laid on the chassis 14-B from the front side. Therefore, the support pin 29-B is passed through the opening 47 while the lamp gripping portions 28-B are passed through the openings 46, where the mounting is permitted. At this point, the regular state of the reflecting sheet 23-B described above means the state in which, when the reflecting sheet 23-B is rotated by 180 degrees in the surfaces along the X-axis direction and the Y-axis direction, the opening 47 that is eccentrically disposed (disposed at asymmetric position) is not aligned with the support pin 29-B although the openings 46 are aligned with the lamp gripping portions 28-B. Accordingly, this configuration restricts the reflecting sheet 23-B from being attached in an orientation other than the predetermined orientation.

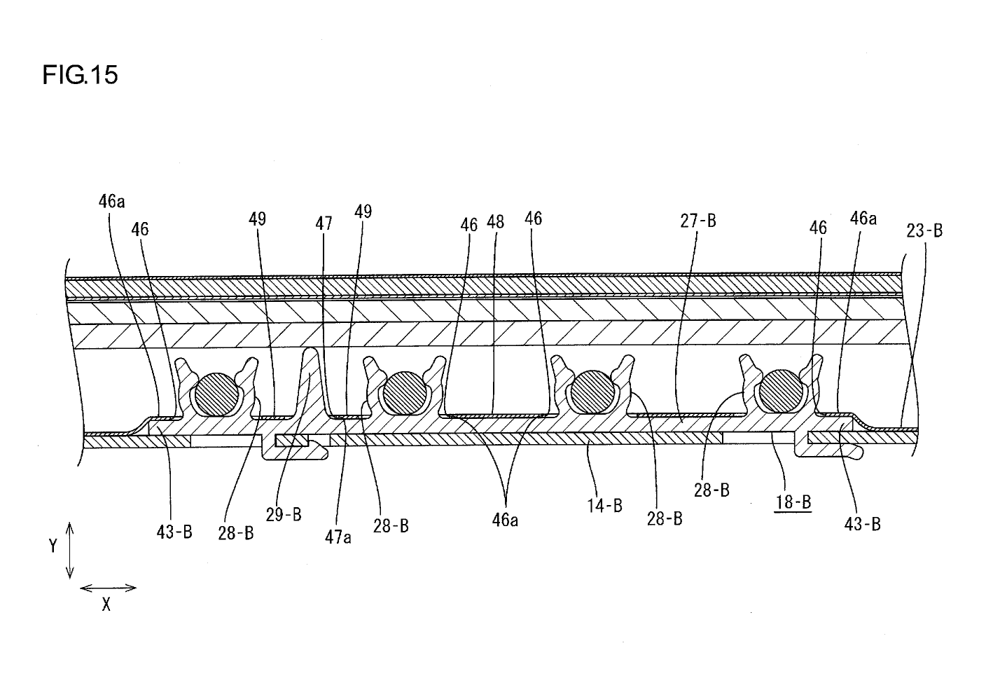

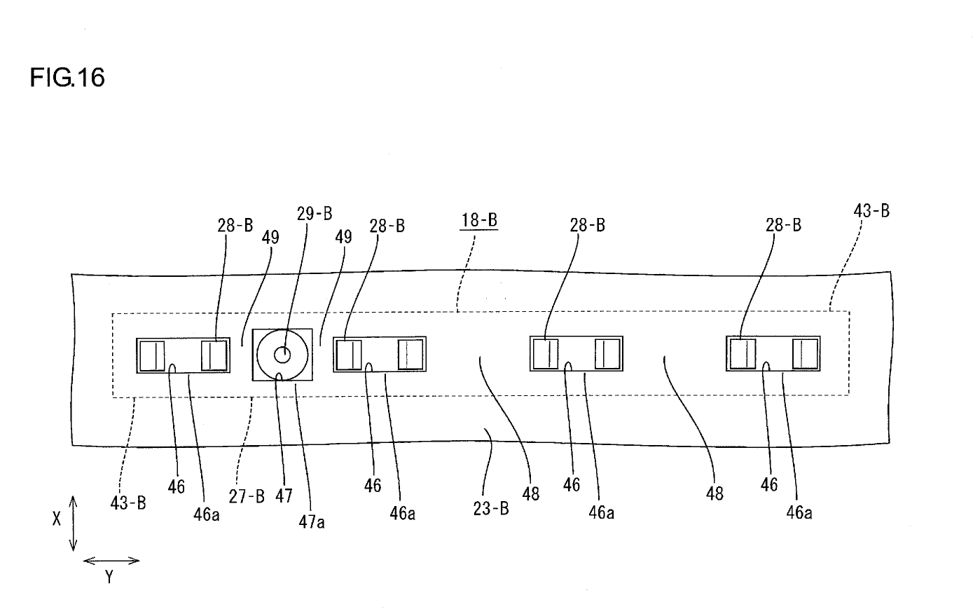

When the reflecting sheet 23-B is attached to the chassis 14-B, as illustrated in FIGS. 15 and 16, the outer edge portion 43-B of the main body 27-B is covered over the whole circumference with the portion of the inner edge portions 46a, 47a of the openings 46, 47 except the covering portions 48 and 49, and the portion of the main body 27-B between the adjacent lamp gripping portions 28-B and the portion of the main body 27-B between the lamp gripping portion 28-B and support pin 29-B which are adjacent to each other are covered with the covering portions 48 and 49. Thus, in the main body 27-B, not only the outer edge portion 43-B is covered over the whole circumference with the reflecting sheet 23-B, but also the portion between the adjacent lamp gripping portions 28-B and the portion between the lamp gripping portion 28-B and support pin 29-B which are adjacent to each other are covered with the reflecting sheet 23-B, whereby the area covered with the reflecting sheet 23-B further is increased compared with the first and second embodiments described above. Accordingly, even if the lamp clip 18-B differs from the reflecting sheet 23-B in the reflectance. Therefore, the luminance unevenness is further less likely to occur. Additionally, because the covering portion 48 and 49 are formed to be the bridges between the openings 46, 47, the opening widths in the Y-axis direction of the openings 46, 47 are smaller than those of the openings 41 and 41-A of the first and second embodiments. Accordingly, this configuration restricts the reflecting sheet 23-B from being deformed so as to widen the openings 46, 47, and the inner edge portions 46a, 47a of the openings 46, 47 from being deformed by an influence of humidity or the like.

As described above, according to the present embodiment, the plurality of lamp gripping portions 28-B are provided on the main body 27-B. The reflecting sheet 23-B has a plurality of openings 46 such that each of the lamp gripping portions 28-B is inserted in corresponding one of the openings 46. The reflecting sheet 23-B also has the first covering portion 48 that covers an area of the main body 27-B between the adjacent lamp gripping portions 28-B. The first covering portion 48 is located between the adjacent openings 46. Therefore, the portion of the main body 27-B between the adjacent lamp gripping portions 28-B is covered with the first covering portion 48 located between the adjacent openings 46, whereby the covered area of the reflecting sheet 23-B with respect to the lamp clip 18-B is increased. Even if the lamp clip 18-B and the reflecting sheet 23-B have different reflection efficiencies, the luminance unevenness is less likely to occur. The first covering portion 48 bridges between the adjacent openings 46 separated from each other. This restricts the reflecting sheet 23-B from being deformed so as to widen the opening 46-B. In addition, this suppresses the deformation of the inner edge portion 46a of the opening 46-B.

The reflecting sheet 23-B has a plurality of openings 46, 47 such that the lamp gripping portions 28-B and support pin 29-B are inserted in the respective openings 46, 47. The reflecting sheet 23-B also has the second covering portions 49 between the adjacent openings 46, 47. The second covering portions 49 cover the areas of the main body 27-B between the lamp gripping portions 28-B and the adjacent support pin 29-B. Because the areas of the main body 27-B between the lamp gripping portions 28-B and the adjacent support pin 29-B is covered with the second covering portion 49, the areas of the lamp clip 18-B covered by the reflecting sheet 23-B is increased. Even if the lamp clip 18-B and the reflecting sheet 23-B have reflection efficiencies, the luminance unevenness is less likely to occur. Additionally, each second covering portion 49 bridges between the adjacent openings 46, 47 separated from each other. Therefore, reflecting sheet 23-B is restricted form being deformed so as to widen the openings 46, 47. In addition, this suppresses the deformation of the inner edge portions 46a, 47a of the openings 46, 47.

The reflecting sheet 23-B has a plurality of the openings 46, 47 such that the lamp gripping portions 28-B and the support pin 29-B are inserted in the respective openings 46, 47. The reflecting sheet 23-B also has the first covering portion 48 that covers an area of the main body 27-B between the adjacent lamp gripping portions 28-B and the second covering portion 49 that covers an area of the main body 27-B between the lamp gripping portion 28-B and the adjacent support pin 29-B. The first covering portion 48 and the second covering portion 49 are located between the adjacent openings 46, 47, respectively. Therefore, the area of the main body 27-B between the adjacent lamp gripping portions 28-B and the area of the main body 27-B between the lamp gripping portion 28-B and the adjacent support pin 29-B are entirely covered with the first covering portion 48 and second covering portion 49. This further increases the covered area of the reflecting sheet 23-B with respect to the lamp clip 18-B. Accordingly, even if the lamp clip 18-B and the reflecting sheet 23-B have the reflection efficiencies, the luminance unevenness is less likely to occur.

### Fourth Embodiment

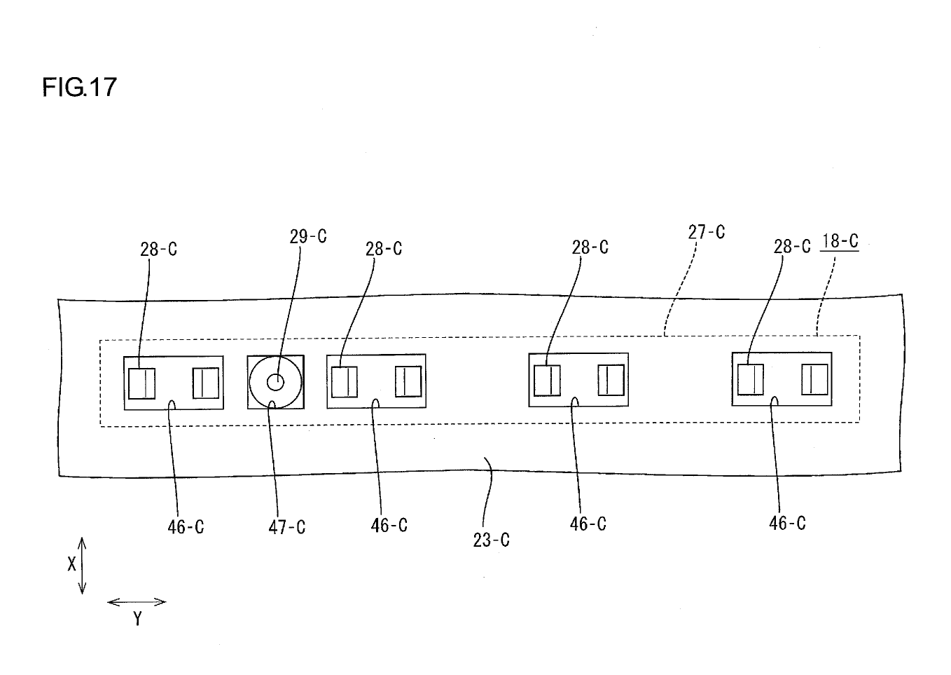

A fourth embodiment of the present invention will be described with reference to FIG. 17. In the fourth embodiment, sizes of openings 46-C, 47-C are changed from the openings 46, 47 of the third embodiment. In the fourth embodiment, the region having the same name as the first embodiment is designated by the same numeral, a suffix “-C” is added to the ending of the numeral, and overlapping descriptions of the structure, action, and effect are omitted.

As illustrated in FIG. 17, each opening 46-C differs from the opening 47-C in the opening width, that is, the opening width in the X-axis direction. More specifically, the opening 46-C is formed such that the dimensions in the X-axis direction and Y-axis direction of the opening 46-C are substantially equal to or slightly larger than those of a lamp gripping portion 28-C. On the other hand, the opening 47-C is formed such that the dimensions in the X-axis direction and Y-axis direction of the opening 47-C are substantially equal to or slightly larger than those of a support pin 29-C. Accordingly, the opening width in the X-axis direction of the opening 46-C is smaller than that of the opening 47-C. In the present embodiment, a covered area of a reflecting sheet 23-C with respect to a main body 27-C is increased compared with the third embodiment in which all the opening widths in the X-axis direction of the openings 46, 47 are equalized. Therefore, because the substantially whole surface of the main body 27-C can be covered with the reflecting sheet 23-C, this configuration is further effectively used as the countermeasure for the luminance unevenness.

As described above, according to the present embodiment, the lamp gripping portions 28-C and the support pin 29-C are provided such that the distance from the outer edge of the lamp gripping portion 28-C to the outer edge of the main body 27-C differs from the distance from the outer end of the support pin 29-C to the outer edge of the main body 27-C. The distances measure in the direction perpendicular to the direction in which the lamp gripping portions 28-C and the support pin 29-C are aligned. The width of the opening 47-C that measures at a part through which one of the lamp gripping portion a openings 46-C, 47-C having the smaller distance between the lamp gripping portion 28-C and the support pin 29-C is passed becomes larger, and the opening width of the opening 46-C through which one of the openings 46-C, 47-C having the larger distance between the lamp gripping portion 28-C and the support pin 29-C is passed becomes smaller. In the direction orthogonal to the direction in which the lamp gripping portions 28-C and the support pin 29-C are arrayed, even if the lamp gripping portion 28-C differs from the support pin 29-C in the size, the covered area of the reflecting sheet 23-C with respect to the lamp clip 18-C can be enlarged by forming the openings 46-C, 47-C into the opening width corresponding to the sizes of the lamp gripping portions 28-C and support pin 29-C. Therefore, even if the lamp clip 18-C differs from the reflecting sheet 23-C in the reflection efficiency. Therefore, the luminance unevenness is further less likely to occur.

### Fifth Embodiment

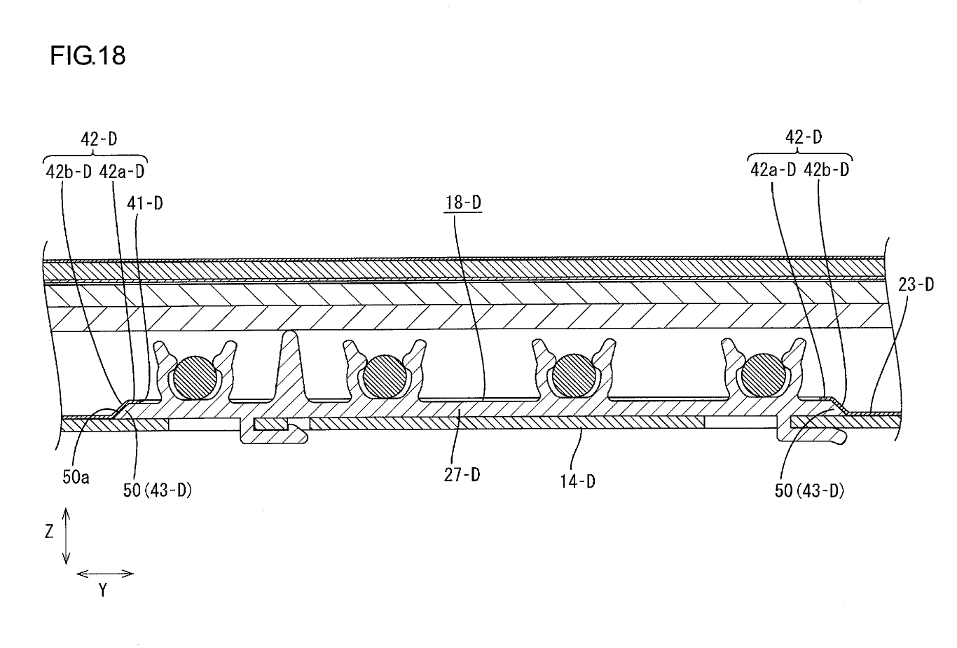

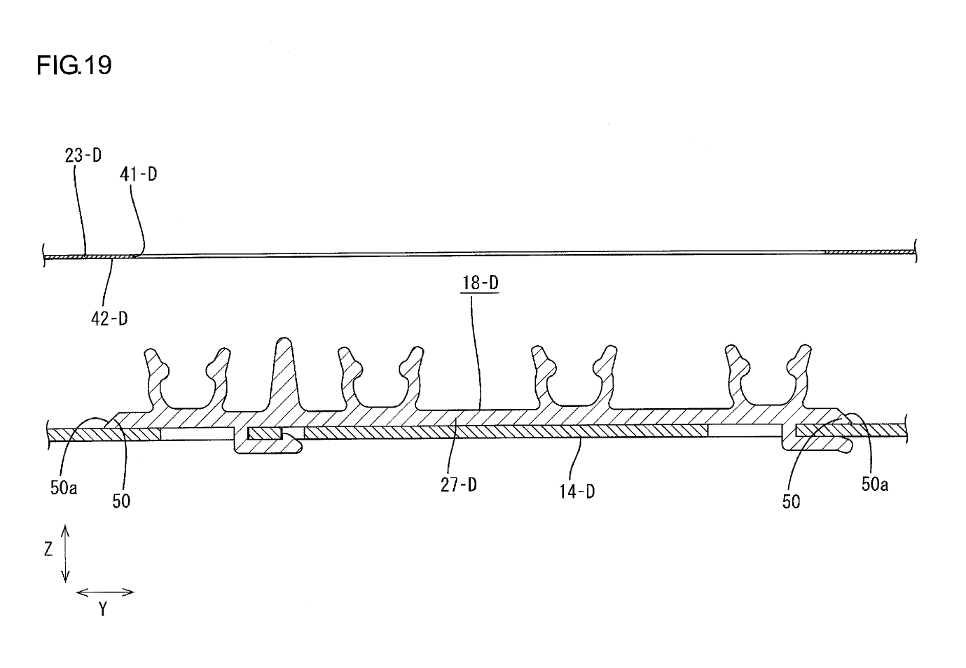

A fifth embodiment of the present invention will be described with reference to FIG. 18 or 19. In the fifth embodiment, a shape of a lamp clip 18-D is changed. In the fifth embodiment, the region having the same name as the first embodiment is designated by the same numeral, a suffix “-D” is added to the ending of the numeral, and overlapping descriptions of the structure, action, and effect are omitted.

As illustrated in FIG. 18, a spread-out portion 50 that is spread out toward the outer end side is provided in an outer edge portion 43-D of a main body 27-D in a lamp clip 18-D. The spread-out portion 50 is formed over the whole circumference of an outer circumference edge of the main body 27-D. The spread-out portion 50 has the shape in which the thickness decreases continuously and gradually from the inner end side toward the outer end side. That is, the spread-out portion 50 is formed into the substantially triangular shape in section, and the surface on the front side, that is, the surface opposite to the reflecting sheet 23-D constitutes an inclined surface 50a having a falling slope from the inner end side toward the outer end side. Accordingly, a corner portion on the front side in the outer edge portion 43-D of the main body 27-D forms an obtuse angle.

In mounting the reflecting sheet 23-D on the chassis 14-D, the outer edge portion 43-D of the main body 27-D is covered with an inner edge portion 42-D of an opening 41-D when the reflecting sheet 23-D is laid on the chassis 14-D in the state illustrated in FIG. 19. At this point, even if the inner edge portion 42-D of the opening 41-D is pushed into the outer edge portion 43-D of the main body 27-D, the corner portion on the front side in the outer edge portion 43-D of the main body 27-D forms the obtuse angle as described above. As a consequence, this configuration restricts the reflecting sheet 23-D from being damaged. In the state with the reflecting sheet 23-D being attached, as illustrated in FIG. 18, an overlapping portion 42a-D in the inner edge portion 42-D of the opening 41-D runs over the outer edge portion 43-D of the main body 27-D, and an inclined portion 42b-D runs over the spread-out portion 50. The inclined portion 42b-D is supported from the backside by the spread-out portion 50, whereby the inclined portion 42b-D is maintained in the similar spread-out shape. That is, because the generation of a gap between the inclined portion 42b-D and the outer edge portion 43-D of the main body 27-D is avoided, the shape of the inclined portion 42b-D can stably be maintained. Therefore, this configuration stably exerts the function of reducing the luminance unevenness.

As described above, according to the present embodiment, the outer edge portion 43-D of the main body 27-D is formed into the shape that is spread out toward the outer end side. Accordingly, because the reflecting sheet 23-D is laid on along the spread-out outer edge portion 43-D of the main body 27-D, the inner edge portion 42-D of the opening 41-D that covers the outer edge portion 43-D of the main body 27-D is maintained in the similar spread-out shape. Therefore, the luminance unevenness is less likely to occur. This configuration also restricts the reflecting sheet 23-D from interfering in the outer edge portion 43-D of the main body 27-D to generate the damage.

### Sixth Embodiment

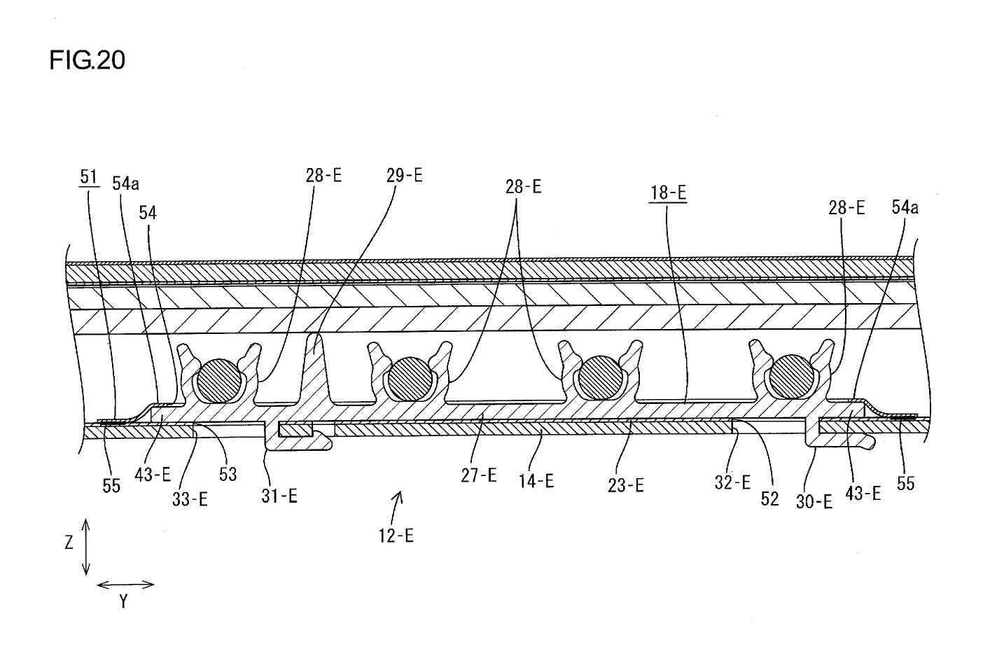

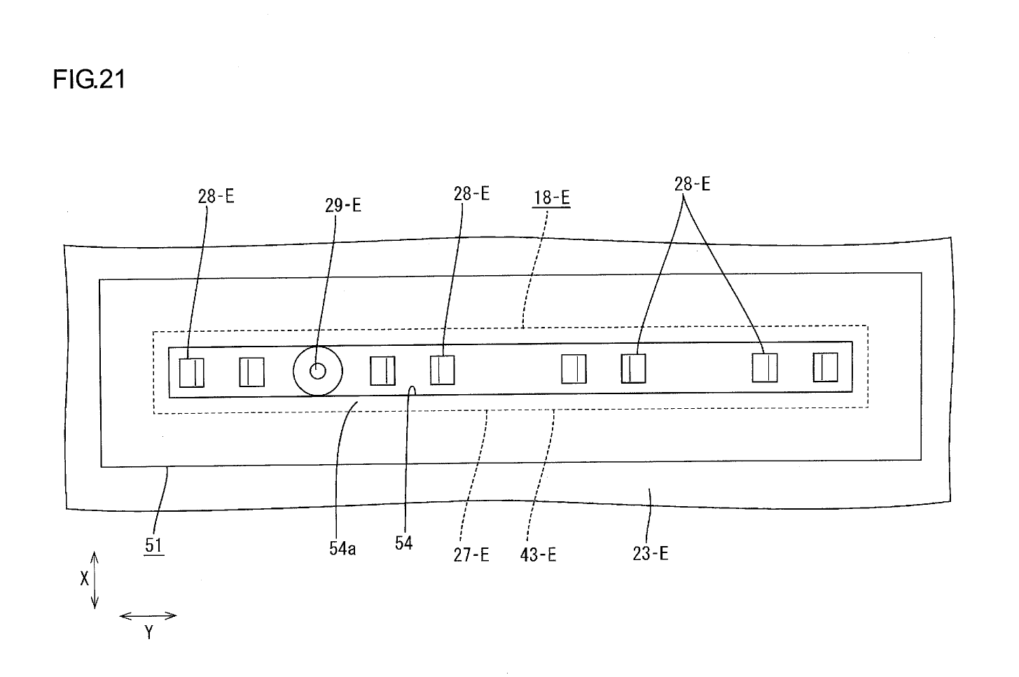

A sixth embodiment of the present invention will be described with reference to FIG. 20 or 21. In the sixth embodiment, a reflecting member 51 that covers the main body is prepared separately from a reflecting sheet 23-E constituting a backlight device 12-E. In the sixth embodiment, the region having the same name as the first embodiment is designated by the same numeral, a suffix “-E” is added to the ending of the numeral, and overlapping descriptions of the structure, action, and effect are omitted.

As illustrated in FIG. 20, the reflecting sheet 23-E is placed between a chassis 14-E and a main body 27-E of a lamp clip 18-E. In other words, the reflecting sheet 23-E is attached to the chassis 14-E before the lamp clip 18-E is mounted. Insertion holes 52 and 53 in which mounting portions 30-E and 31-E of the lamp clip 18-E can be inserted are made in the reflecting sheet 23-E at positions aligned with mounting holes 32-E and 33-E of the chassis 14-E.

A reflecting member 51 that is a different component from the reflecting sheet 23-E is laid on the lamp clip 18-E that is mounted on the chassis 14-E with the reflecting sheet 23-E placed therebetween. The reflecting member 51 is made of the same material as the reflecting sheet 23-E. As illustrated in FIG. 21, the reflecting member 51 is formed into the rectangular shape that is larger than the main body 27-E in the X-axis direction and Y-axis direction, and a rectangular opening 54 through which the lamp gripping portion 28-E and the support pin 29-E can collectively be passed is provided in the center of the reflecting member 51. Because the opening 54 is similar to the opening 41 of the first embodiment, the detailed description is omitted. In the reflecting member 51, a double-sided adhesive tape 55 is placed between the outer edge portion and the reflecting sheet 23-E in order to fix the outer edge portion and the reflecting sheet 23-E.

The work that mounts each lamp clip 18-E is performed after the reflecting sheet 23-E is attached to the chassis 14-E. Then the work that separately mounts the reflecting member 51 corresponding to each lamp clip 18-E is performed. When the reflecting member 51 is laid on the lamp clip 18-E while the opening 54 is positioned with respect to the lamp gripping portions 28-E and support pin 29-E in the lamp clip 18-E that should be mounted, the lamp gripping portions 28-E and the support pin 29-E are passed through the opening 54. When the reflecting member 51 is attached, the outer edge portion 43-E of the main body 27-E is covered over the whole circumference with an inner edge portion 54a of the opening 54, and the outer edge portion of the reflecting member 51 and the reflecting sheet 23-E are adhered rigidly by the double-sided adhesive tape 55.

### Seventh Embodiment

A seventh embodiment of the present invention will be described with reference to FIGS. 38 to 42. In the seventh embodiment, structures of mounting portions 30-F and 31-F and mounting holes 32-F and 33-F are changed. In the seventh embodiment, the region having the same name as the first embodiment is designated by the same numeral, a suffix “-F” is added to the ending of the numeral, and overlapping descriptions of the structure, action, and effect are omitted.

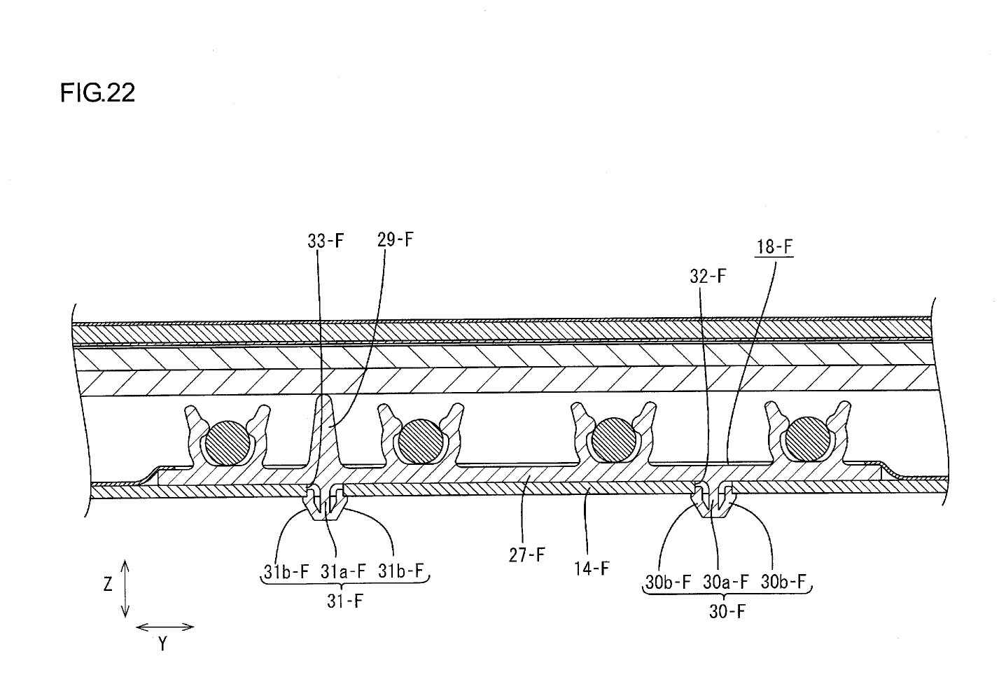

As illustrated in FIG. 22, the mounting portions 30-F and 31-F include base portions 30a-F and 31a-F that are projected from the rear surface of the main body 27-F, and pairs of projections 30b-F and 31b-F that are folded toward the side of the main body 27-F from leading ends of the base portions 30a-F and 31a-F to face the base portions 30a-F and 31a-F, respectively. The projections 30b-F and 31b-F-F are formed into cantilever shapes, and the projections 30b-F and 31b-F can elastically be deformed so as to come close to the sides of the base portions 30a-F and 31a-F, and stepwise latching surfaces are formed in the leading end portions thereof. The mounting holes 32-F and 33-F of the chassis 14-F have a diameter that is substantially equal to an interval between the latching surfaces in the projections 30b-F and 31b-F-F.

When the lamp clip 18-F is pushed into the chassis 14-F along the Z-axis direction from the front side, the mounting portions 30-F and 31-F are inserted in the mounting holes 32-F and 33-F to tentatively and elastically deform the projections 30b-F and 31b-F. When the lamp clip 18-F is pushed into a regular depth, the mounting portions 30-F and 31-F are projected to the backside of the chassis 14-F, and the projections 30b-F and 31b-F-F are restored to latch the latching surfaces in peripheral edge portions of the mounting holes 32-F and 33-F in the chassis 14-F from the backside. With this configuration, the lamp clip 18-F is maintained in the mounted state with respect to the chassis 14-F. In addition to the lamp clip 18 of the slide-mount type of the first to sixth embodiments, this configuration also preferably reduces the luminance unevenness in the lamp clip 18-F of the push-mount type of the seventh embodiment. Additionally, because the second mounting portion 31-F is placed immediately below the support pin 29-F, operability is improved in mounting the lamp clip 18-F on the chassis 14-F.

### Eighth Embodiment

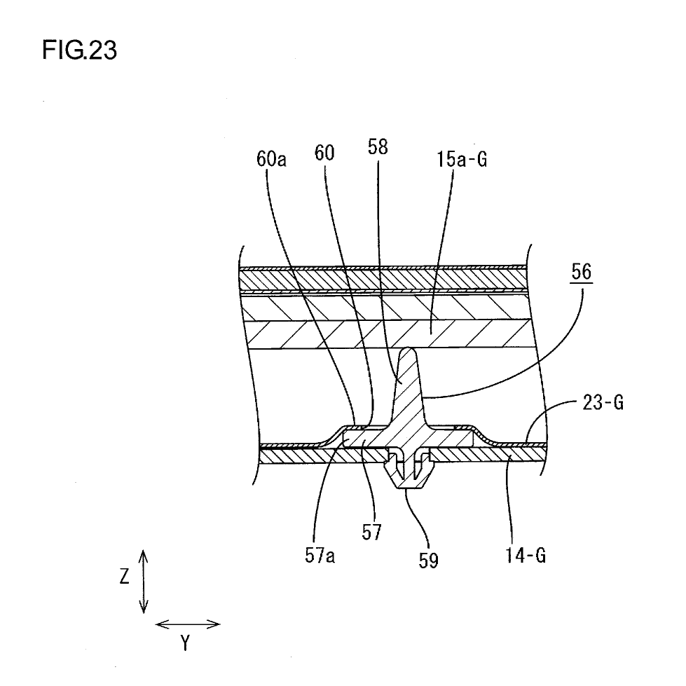

An eighth embodiment of the present invention will be described with reference to FIG. 23. In the eighth embodiment, an optical member support 56 is provided in order to support a diffuser plate 15a-G that is of an optical member. In the eighth embodiment, the region having the same name as the first embodiment is designated by the same numeral, a suffix “-G” is added to the ending of the numeral, and overlapping descriptions of the structure, action, and effect are omitted.

As illustrated in FIG. 23, the optical member support 56 is a different component from the lamp clip, and is made of a synthetic resin having excellent reflectance. The optical member support 56 includes a substantially plate-like main body 57 that is mounted on a chassis 14-G, and a substantially conical support pin 58 that is projected from the main body 57 toward the front side. That is, the optical member support 56 is configured such that the lamp gripping portion 28 is eliminated from the lamp clip 18 in the first to seventh embodiments. Because the main body 57 and support pin 58 which constitute the optical member support 56 are substantially similar to the main body 27 and support pin 29 of the lamp clip 18 illustrated in the first to seventh embodiments, the detailed description is omitted. Because a mounting portion 59 of the optical member support 56 is substantially similar to the mounting portions 30-F and 31-F of the lamp clip 18-F illustrated in the seventh embodiment, the detailed description is omitted.

An opening 60 through which the support pin 58 of the optical member support 56 is passed is provided in a reflecting sheet 23-G. The opening 60 is formed into a size that is smaller than the main body 57 of the optical member support 56. When the reflecting sheet 23-G is laid on from the front side of the optical member support 56 while the optical member support 56 is mounted on the chassis 14-G, an outer edge portion 57a of the main body 57 of the optical member support 56 is covered over the whole circumference with the inner edge portion 60a of the opening 60. Therefore, the outer edge portion 57a of the main body 57 of the optical member support 56 is hardly visually recognized as the shadow, and whereby the ratio of the surface area of the optical member support 56 to the surface area of the reflecting sheet 23-G is decreased by the area in which the optical member support 56 is covered with the reflecting sheet 23-G. Accordingly, this configuration is suitable to reduce the luminance unevenness.

As described above, according to the present embodiment, in the optical member support 56 including the main body 57 that is mounted on the chassis 14-G, and the support pin 58 that is provided in the main body 57 to be able to support the diffuser plate 15a-G, the opening 60 through which the support pin 58 is passed is provided in the reflecting sheet 23-G, and the outer edge portion 57a of the main body 57 is covered with the inner edge portion 60a of the opening 60. Therefore, the support pin 58-G of the optical member support 56, which supports the diffuser plate 15a-G is passed through the opening 60 of the reflecting sheet 23-G, and the outer edge portion 57a of the main body 57 is covered with the inner edge portion 60a of the opening 60, so that the outer edge portion 57a of the main body 57, which forms the step between the outer edge portion 57a and the chassis 14-G, is hardly visually recognized as the shadow. In the present embodiment, the reflecting sheet 23-G reduces the generation of the shadow in the outer edge portion 57a of the main body 57, so that the general-purpose product can be used as the optical member support 56 to achieve the cost reduction. Additionally, because the optical member support 56 is covered with the reflecting sheet 23-G, the ratio of the surface area of the optical member support 56 to the surface area of the reflecting sheet 23-G is decreased. Therefore, the luminance unevenness is less likely to occur even if the optical member support 56 and the reflecting sheet 23-G have different reflection efficiencies. Accordingly, this configuration is suitable to the thinner liquid crystal display device.

### Another Embodiment

The present invention is not limited to the embodiment explained by the description and drawings, but, for example, the following embodiments are also included in the technical scope of the invention.

(1) In the first to seventh embodiments described above, the opening of the reflecting sheet surrounds the lamp gripping portions and the support pin in the lamp clip collectively, or the opening individually passes the lamp gripping portions and the support pin in the lamp clip therethrough. On the other hand, the invention may also encompass a configuration in which an individual opening through which the lamp gripping portion or the support pin is individually passed and a collective opening through which the plurality of lamp gripping portions are collectively passed or a composite type collective opening through which the lamp gripping portion and the support pin are collectively passed are combined.

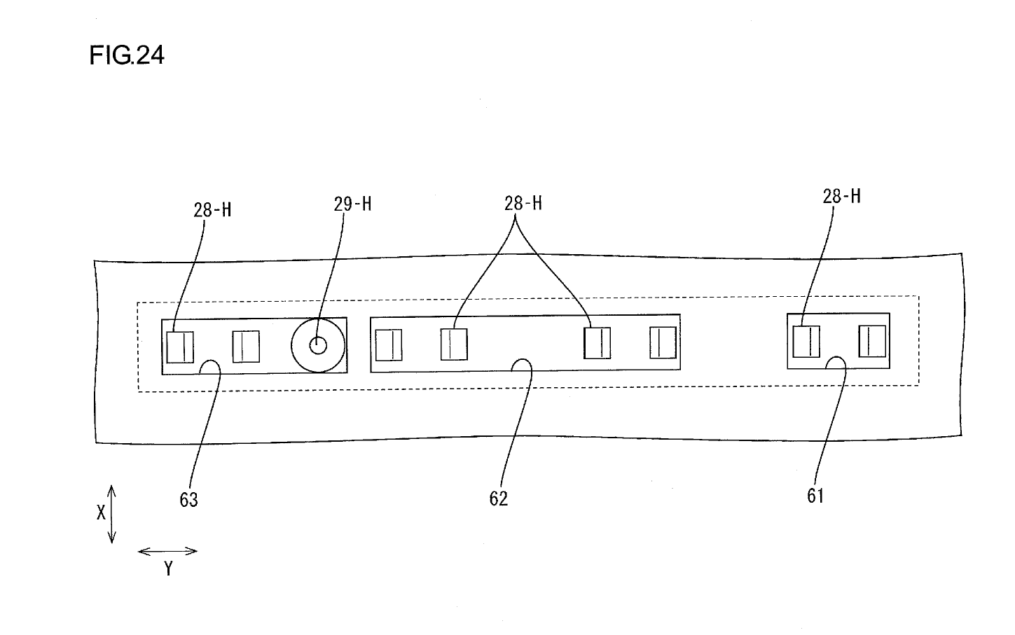

(2) For example, as illustrated in FIG. 24, a lamp gripping portion individual opening 61 through which one lamp gripping portion 28-H is passed, a lamp gripping portion collective opening 62 through which two lamp gripping portions 28-H are collectively passed, and a composite type collective opening 63 through which one lamp gripping portion 28-H and one support pin 29-H are collectively passed may be provided as a specific example of the above description (1). In addition to the configuration illustrated in FIG. 24, the number of openings and the like can appropriately be changed.

(3) In the embodiments described above, the outer edge portion of the main body is covered over the whole circumference with the inner edge portion of the opening. On the other hand, the invention may also encompass a configuration in which the outer edge portion of the main body is partially covered. For example, when at least the long-side outer edge portion in the outer edge portion of the main body is covered with the inner edge portion of the opening, the short-side outer edge portion is hardly noticeable as the shadow even if the short-side outer edge portion in the outer edge portion of the main body is exposed. Therefore, a certain effect of suppressing the luminance unevenness is obtained.

(4) In addition to the above description (3), for example, in a configuration in which the lamp gripping portion or the support pin is formed in the total width region of the main body, the outer edge portion of the main body may be covered with the inner edge portion of the opening with respect to the portion except the portion in which the lamp gripping portion or the support pin is placed. The invention may also encompass this configuration. Additionally, the range where the outer edge portion of the main body is covered with the inner edge portion of the opening can appropriately be changed.

(5) In the third and fourth embodiments described above, the opening through which the support pin is passed is formed into the quadrangular shape according to other openings for lamp gripping portions. The invention may also encompass a configuration in which the opening for a support ping is formed into a circular shape according to (along) a planar shape (outer shape) of the support pin. Therefore, the covered area of the reflecting sheet with respect to the main body can further be increased.

(6) In addition to the embodiments described above, the sizes, shapes and the number of lamp gripping portions or support pins can appropriately be changed. Correspondingly, the size, shape and the number of openings can also appropriately be changed. Specifically, in the embodiments described above, the lamp gripping portion in the X-axis direction is smaller than the support pin in the X-axis direction. On the other hand, the invention may also encompass a configuration in which the support pin is smaller than the lamp gripping portion. At this point, the technology described in the second and fourth embodiments is applied to match the opening width of the opening with the sizes of the lamp gripping portions and support pin, which allows the covered area of the reflecting sheet with respect to the main body to be increased.

(7) In the third and fourth embodiments described above, each covering portion is formed to be the bridge between the adjacent openings. On the other hand, the invention may also encompass a configuration in which the covering portion is cut by a slit in midstream while the adjacent openings are communicated by the slit. Therefore, the covering portion can be deformed so as to turn up at the slit, so that the work that passes the lamp gripping portions and support pin through the opening is facilitated in mounting the reflecting sheet. In the mounted state, the increase in covered area of the reflecting sheet with respect to the main body can be achieved by covering the main body with the covering portion.

(8) In the embodiments described above, the main body is formed into the rectangular shape. Additionally, the invention may also encompass, for example, a configuration in which the main body is formed into a square shape, a circular shape, or an ellipsoidal shape.

(9) In addition to the embodiments described above, the point at which the double-sided adhesive tape is placed can appropriately be changed. For example, the double-sided adhesive tape may be placed near the chassis or the outer edge portion in the reflecting sheet.

(10) In the embodiments described above, the double-sided adhesive tape is used as the mounting member that mounts the reflecting sheet on the chassis by way of example. Alternatively, for example, an adhesive agent may be used. Alternatively, another mounting member that mechanically or chemically fixes the reflecting sheet to the chassis can be used.

(11) Except the embodiments described above, the numbers of mounting portions and mounting holes can appropriately be changed. The shapes of the mounting portion and mounting hole can appropriately be changed.

(12) In the embodiments described above, the mounting portion and the mounting hole are made in order to mount the lamp clip on the chassis. The invention may also encompass, for example, a configuration, in which the lamp clip is mounted on the chassis by interposing the double-sided adhesive tape between the chassis and the rear surface of the main body in the lamp clip to eliminate the mounting portion and the mounting hole.

(13) In the embodiments described above, the cold-cathode tube is used as the light source. The invention may also encompass a configuration in which another kind of light source such as a hot-cathode tube is used.

(14) In the embodiments, the chassis is made of the sheet metal. Alternatively the chassis may be formed by resin molding.

(15) In the embodiments described above, the TFT is used as the switching element of the liquid crystal display device. Additionally, the invention can be applied to a liquid crystal display device in which a switching element (such as Thin Film Diode (TFD)) except the TFT is used, and can also be applied to a monochrome liquid crystal display device in addition to the color liquid crystal display device.

(16) In the embodiments described above, the liquid crystal display device in which the liquid crystal panel is used is illustrated as the display panel. The invention can also be applied to a display device in which another kind of display panel is used.

(17) In the embodiments described above, the television receiver including the tuner is illustrated. The invention can also be applied to a display device that does not include the tuner.

1. An illuminating device comprising:
a chassis;
a lamp disposed in the chassis;
a lamp holder including a main body and a lamp gripping portion, the main body being mounted on the chassis, the lamp gripping portion being provided on the main body so as to grip the lamp; and
a reflecting member that is disposed in the chassis,
wherein the reflecting member has an opening through which the lamp gripping portion is passed and an inner edge portion thereof covers an outer edge portion of the main body.

2. The illuminating device according to claim 1, wherein the main body has a rectangular shape, and at least a long-side outer edge portion of the main body is covered with the inner edge portion of the opening of the reflecting member.

3. The illuminating device according to claim 1, wherein the entire outer edge portion of the main body is covered with the inner edge portion of the opening of the reflecting member.

4. The illuminating device according to claim 1, wherein:
a plurality of the lamp gripping portions are provided on the main body; and
the lamp gripping portions are all inserted in the opening.

5. The illuminating device according to claim 1, wherein:
a plurality of the lamp gripping portions are provided on the main body;
the reflecting member has a plurality of the openings such that each of the lamp gripping portions is inserted in corresponding one of the openings; and
the reflecting member has a covering portion between the adjacent openings, the covering portion covering an area of the main body between the adjacent lamp gripping portions.

6. The illuminating device according to claim 5, wherein the covering portion bridges between the adjacent openings separated from each other.

7. The illuminating device according to claim 1, further comprising an optical member disposed such that the lamp is sandwiched between the optical member and the chassis, wherein the lamp holder includes a support portion that supports the optical member, the support portion provided on the main body and passed through the opening.

8. The illuminating device according to claim 7, wherein the lamp gripping portion and the support portion are inserted in corresponding one of the openings.

9. The illuminating device according to claim 7, wherein:
the reflecting member has a plurality of the openings such that the lamp gripping portion and the support portion are inserted in the respective openings; and
the reflecting member has a covering portion between the adjacent openings, the covering portion covering an area of the main body between the lamp gripping portion and the adjacent support portion.

10. The illuminating device according to claim 9, wherein the covering portion between the lamp gripping portion and the support portion bridges between the adjacent openings separated from each other.

11. The illuminating device according to claim 7, wherein:
the lamp gripping portion and the support portion are provided such that a distance from an outer edge of the lamp gripping portion to an outer edge of the main body differs from a distance from an outer edge of the support portion to the outer edge of the main body, the distances measuring in a direction perpendicular to a direction in which the lamp gripping portion and the support portion are aligned; and
the opening has a part having a small width and a part having a large width such that one of the lamp gripping portion and the support portion, whichever the distance to the outer edge of the main body is smaller, is passed through the part having the large width, and the other, the distance from which to the outer edge of the main body is larger, is passed through the part having the small width.

12. The illuminating device according to claim 1, further comprising an optical member disposed such that the lamp is sandwiched between the optical member and the chassis, wherein:
the lamp holder includes a support portion that supports the optical member and a plurality of the lamp gripping portions, the support portion and the lamp gripping portions being provided on the main body;
the opening is formed such that the support portion passes therethrough; and the lamp gripping portions and the support portion are all inserted therein.

13. The illuminating device according to claim 12, wherein the opening has a width that is constant over a total length, the width measuring in a direction perpendicular to a direction in which the lamp gripping portions and the support portion are aligned.

14. The illuminating device according to claim 1, further comprising an optical member disposed such that the lamp is sandwiched between the optical member and the chassis, wherein:
the lamp holder includes a support portion that supports the optical member and a plurality of the lamp gripping portions including at least two provided adjacent to each other, the support portion and the lamp gripping portions being provided on the main body;
the reflecting member has a plurality of the openings in which the lamp gripping portions and the support portion are inserted, respectively;
the reflecting member has a first covering portion that covers a middle portion of the main body between the adjacent lamp gripping portions and a second covering portion that covers a middle portion of the main body between the lamp gripping portion and the adjacent support portion; and
the first covering portion and the second covering portion are provided between the adjacent openings.

15. The illuminating device according to claim 1, further comprising a mounting member for fixing the reflecting member to the chassis.

16. The illuminating device according to claim 15, wherein the mounting member is a double-sided adhesive tape that is placed between the chassis and the reflecting member, the double-sided adhesive tape having adhesive layers on a front surface and a rear surface.

17. The illuminating device according to claim 1, wherein:
a plurality of the lamp holders are mounted on the chassis; and
the reflecting member has a plurality of openings at positions corresponding to the lamp holders.

18. The illuminating device according to claim 17, wherein the reflecting member covers a substantially whole area of the chassis.

19. The illuminating device according to claim 1, wherein the outer edge portion of the main body is formed so as to be sloped toward an outer end edge thereof.

20. An illuminating device comprising:
a chassis;
a lamp disposed in the chassis;
an optical member disposed such that the lamp is sandwiched between the optical member and the chassis;
an optical member support including a main body and a support portion, the main body being mounted on the chassis, the support portion being provided on the main body so as to support the optical member; and
a reflecting member disposed in the chassis,
wherein the reflecting member has an opening through which the support portion is passed and an inner edge portion of the opening covers an outer edge portion of the main body.

21. A display device comprising:
the illuminating device according to claim 1; and
a display panel that is disposed in front of the illuminating device.

22. The display device according to claim 21, wherein the display panel is a liquid crystal panel in which liquid crystal is sealed between a pair of substrates.

23. A television receiver comprising the display device according to claim 21.
